(19) United States
(12) Patent Application Publication
(10) Pub. No.: US 2006/0034266 A1
(43) Pub. Date: Feb. 16, 2006

(54) System and method for providing content via IP video telephone network

(76) Inventors: John C. Harris, Rockwall, TX (US); Brad Stacy Shirley, Plano, TX (US); Guenter Hanfried Lehmann, Sachse, TX (US); Rene M. Cardenas, Dallas, TX (US); Michael R. Wilkinson, Richardson, TX (US); H. Michael Willey, Garland, TX (US); Jason A. Lickliter, Frisco, TX (US); CC Fichtner, Dallas, TX (US)

Correspondence Address: HOWISON & ARNOTT, L.L.P, P.O. BOX 741715, DALLAS, TX, 75374-1715, US

(21) Appl. No.: 11/194,053

(22) Filed: Jul. 29, 2005

Related U.S. Application Data
(60) Provisional application No. 11/184,035, filed on Aug. 4, 2004.
(60) Provisional application No. 60/599,706, filed on Aug. 6, 2004.
(60) Provisional application No. 60/599,710, filed on Aug. 6, 2004.
(60) Provisional application No. 60/599,728, filed on Aug. 6, 2004.
(60) Provisional application No. 60/599,615, filed on Aug. 6, 2004.
(60) Provisional application No. 60/600,013, filed on Aug. 9, 2004.
(60) Provisional application No. 60/600,904, filed on Aug. 12, 2004.
(60) Provisional application No. 60/641,684, filed on Jan. 5, 2005.
(60) Provisional application No. 60/641,883, filed on Jan. 5, 2005.
(60) Provisional application No. 60/641,326, filed on Jan. 4, 2005.
(60) Provisional application No. 60/641,328, filed on Jan. 4, 2005.

(51) Int. Cl. H04L 12/66

(52) U.S. Cl. 370/356

(57) ABSTRACT

A system for providing interactive data services to a home voice-over-Internet-Protocol (VOIP) user includes a plurality of broadband information appliances. A host server is in communication with the broadband information appliances via a network. At least one media server is in communication with the host server via the network and fulfills requests for media and services from the plurality of broadband information appliances through the host server.

### RELATED INVENTIONS

This application claims priority from U.S. Provisional Application No. 60/598,650 filed Aug. 4, 2004 entitled “ON-DEMAND AUDIO VISUAL PROGRAMMING ON A TWO-WAY TELECOMMUNICATIONS DEVICE”; U.S. Provisional Application No. 60/599,706 filed Aug. 6, 2004 entitled “INTEGRATED DIGITAL MEDIA SERVER AND A/V TELECOMMUNICATION DEVICE”; U.S. Provisional Application No. 60/599,710 filed Aug. 6, 2004 entitled “FORMATTING MEDIA FOR DELIVERY TO AN A/V TELECOMMUNICATION DEVICE”; U.S. Provisional Application No. 60/599,728 filed Aug. 6, 2004 entitled “METHOD OF PROVIDING CONTENT TO AN A/V TELECOMMUNICATION DEVICE”; U.S. Provisional Application No. 60/599,615 filed Aug. 6, 2004 entitled “METHOD OF COMMERCE ON AN A/V TELECOMMUNICATION DEVICE”; U.S. Provisional Application No. 60/600,013 filed Aug. 9, 2004 entitled “PRIVATE BROADCASTING NETWORK FOR AN A/V TELECOMMUNICATION DEVICE”; U.S. Provisional Application No. 60/600,904 filed Aug. 12, 2004 entitled “PRODUCT INFORMATION RETRIEVAL ON AN A/V TELECOMMUNICATION DEVICE”; U.S. Provisional Application No. 60/641,684 filed Jan. 5, 2005 entitled “INNER PROCESSOR COMMUNICATION IN A MULTIPROCESSOR DEVICE”; U.S. Provisional Application No. 60/641,883 filed Jan. 5, 2005 entitled “INNER PROCESSOR COMMUNICATION IN A VOICE OVER IP VIDEO TELEPHONY DEVICE”; U.S. Provisional Application No. 60/641,326 filed Jan. 4, 2005 entitled “METHOD FOR SYNCHRONIZATION OF AUDIO AND VIDEO PACKETS WITHIN AN IP VIDEO TELEPHONE”; and U.S. Provisional Application No. 60/641,328 filed Jan. 4, 2005 entitled “IP VIDEO TELEPHONE WITH POTS TELEPHONE CONNECTIVITY,” all of which are incorporated herein by reference.

### TECHNICAL FIELD OF THE INVENTION

The present invention relates to video telephony, and more particularly, to a voice over IP video telephone capable of operating over an IP network.

### BACKGROUND OF THE INVENTION

The combination of video and audio channels provides a unique platform for interpersonal communication. With the availability of broadband Internet network connections in the home, there is an opportunity to further methods of interaction between content providers and consumers.

An IP telephone is a telephone device that transmits voice over a network using data packets instead of circuit switch connections over voice only networks. An IP telephone refers to the transfer of voice over the Internet protocol (IP) of the TCP/IP protocol suite. Other voice over packet (VOP) standards exist for frame relay and ATM networks but many people use the terms voice over IP (VOIP) or IP telephone to mean voice over any packet network

IP telephones originally existed in the form of client software running on multi-media PCs for low cost PC to PC communications over the Internet. Quality of service (QOS) problems associated with the Internet and the PC platform itself resulted in poor voice quality due to excessive delay, variable delay, and network congestion resulting in lost packets, thus relegating VOIP primarily to hobby status. The QOS provided by the Internet continues to improve as the infrastructure is augmented with faster backbone links and switches to avoid congestion, higher access connections to the end users such as XDSL cut-down latency, and new protocols like RSVP and techniques like tag switching give priority to delay sensitive data such as voice and video. IP telephones include one wire systems for transmitting both voice and data. The data may comprise video data of the user of the IP phone in some embodiments. IP telephones provide better scalability as additional stations are added to the system, and the ability to mix and match IP telephones from different manufacturers.

IP telephones have several advantages over multimedia PCs with client software including lower latencies due to an embedded system implementation, a familiar user paradigm of using a telephone versus a PC enabled phone, greater reliability, and lower station costs where a PC is not required.

When considering IP telephones for home use, the network interface that is available is typically a DSL or cable broadband connection. Typically, IP telephones connect to a cable modem or DSL modem via a high speed interface such as Ethernet or universal serial bus (USB). There are also emerging home communication standards such as being presented by home RF, which provides wireless communication within the home. In this new residential environment, IP telephones will attach to the home LAN and have access to the data network and the PSTN via either a DSL or cable modem which communicates to DSLAM or cable system equipment.

A home voice over IP telephone including video capabilities would provide a platform for providing a number of different services and opportunities to the home user. A platform for implementing this service would be greatly desirable.

### SUMMARY OF THE INVENTION

The present invention disclosed and claim herein, in one aspect thereof, comprises, a system for providing interactive data services to a home voice-over-Internet-Protocol (VOIP) user. The system contains a plurality of broadband information appliances and a host server in communication with the broadband information appliances via a network. At least one media server may be in communication with the host server via the network and is adapted to fulfill requests for media and services from the plurality of broadband information appliances through the host server.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a household broadband information appliance;

FIG. 2 illustrates a handset for a household broadband information appliance;

FIG. 3 illustrates a block diagram of a household broadband information appliance;

FIG. 4 illustrates a block diagram of an IP video telephone;

FIG. 5 is a functional block diagram of the gateway of the IP video telephone;

FIG. 6 is a functional block diagram of the voice over IP processor of the IP video telephone;

FIG. 7 is a functional block diagram of the video processor of the IP video telephone;

FIGS. 8a-8c indicate the various manners in which processing components of the IP video telephone may be interconnected via an Ethernet network;

FIGS. 9a and 9b illustrate analog telephone connections to the IP video telephone;

FIG. 10 is an illustration of a call connection process using the IP video telephone;

FIG. 11 illustrates the manner in which delay may be created between video and audio packets when transmitted over an IP network;

FIG. 12 is a flow diagram illustrating one method for synchronizing audio and video packets;

FIG. 13 illustrates the method of inserting delays into the transmission of packets to achieve synchronization at a receiving end of audio and video packets;

FIG. 14 is an illustration of a home display displayed on the video screen of the IP video telephone;

FIG. 15 is an illustration of the calendar display on the display of the IP video telephone;

FIG. 16 is an illustration of the telephone display on the display of the IP video telephone;

FIG. 17 illustrates other display screens of the IP video telephone;

FIG. 18 illustrates inter unit communications between device processors;

FIG. 19 illustrates the software modules enabling communicating between a pair of IP video telephones;

FIG. 20 illustrates the manner that a stun module interacts with an IP video telephone;

FIG. 21 is a flow diagram illustrating a call connection using the software of FIG. 20;

FIG. 22 is a flow diagram illustrating a call receipt process;

FIG. 23 illustrates one embodiment of an operating environment for an IP video telephone;

FIG. 24 is a flow diagram corresponding to a method of verifying payment for media service;

FIG. 25 is a flow diagram illustrating partial functionality of one operating environment for an IP video telephone;

FIG. 26 is a flow diagram illustrating additional functionality of one operating environment for an IP video telephone;

FIG. 27 illustrates another embodiment of an operating environment for an IP video telephone;

FIG. 28 is another flow diagram illustrating partial functionality of one environment for an IP video telephone;

FIG. 29 illustrates another embodiment of an operating environment for an IP video telephone.

FIG. 30 is a flow diagram illustrating partial functionality of one environment for an IP video telephone;

FIG. 31 illustrates another embodiment of an operating environment for an IP video telephone;

FIG. 32 is flow diagram illustrating one embodiment of a method of providing messaging services to IP video telephones;

FIG. 33 is a flow diagram illustrating apart of the operation of an interactive messaging system; and

FIG. 34 is a flow diagram illustrating a portion of the process flow of a recipient accessing from an IP video telephone.

FIG. 35 is a flow diagram illustrating partial operation of a hold function for an IP video telephone.

FIG. 36 illustrates another embodiment of an operating environment an IP video telephone.

FIG. 37 is a flow diagram illustrating a portion of the process flow of the operation of the environment of FIG. 36.

FIG. 38 illustrates another operating environment for an IP video telephone.

FIG. 39 is a flow diagram illustrating partial functionality of the environment of FIG. 38.

FIG. 40 illustrates another embodiment of an operating environment 4000 an IP video telephone.

FIG. 41 is a flow diagram illustrating partial functionality of the environment of FIG. 40.

FIG. 42 is a flow diagram illustrating additional functionality of the environment of FIG. 40.

FIG. 43 illustrates another embodiment of an operating environment for an IP video telephones.

FIG. 44 is a flow diagram illustrating partial functionality of the environment of FIG. 43.

FIG. 45 illustrates another operating environment an IP video telephone.

FIG. 46 is a flow diagram which illustrates partial functionality of the environment of FIG. 45.

FIG. 47 illustrates another embodiment of an operating environment for an IP video telephones.

FIG. 48 is a flow diagram which illustrates partial functionality of the environment of FIG. 47.

### DETAILED DESCRIPTION OF THE INVENTION

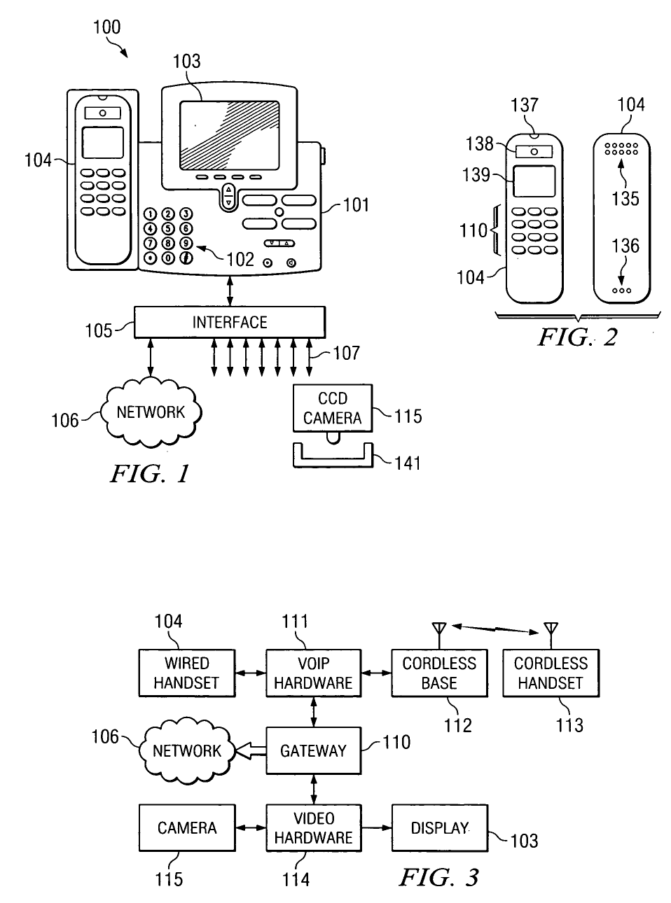

Referring now to the drawings, and more particularly to FIG. 1, there is illustrated a functional depiction of a broadband information appliance 100. The broadband information appliance 100 includes a base unit 101. The base unit 101 typically houses the processing circuits, memory storage, interfaces 105, manual inputs 102 and power connections. The base unit 101 may be attached to a display 103. The display 103 may be integral with the base unit 101. The display 103 may be an independent unit fixedly attached to the base unit 101. The display 103 may be interchangeably attached to the base unit 101 such that the display 103 may be easily exchanged for a different display 103. In a preferred embodiment, the broadband information appliance 100 comprises a video telephone. The video telephone provides the user with the ability to converse with an individual also having a video telephone while providing both audio and video outputs to each user of a video telephone.

The display of the IP video telephone 402 and the browser operating within the video processor 111 are typically left in a powered state to enable content to be received by the IP video telephone 402 at any point. In this manner, when the IP video telephone is not presently operating with supporting an audio/visual telephone call, the browser may be used to display content to an individual on the screen of the IP video telephone. This enables a host server interconnected with the IP video telephone 402 through a network such as the Internet to consistently provide advertising or other types of directed information on the display of the IP video telephone through the browser. This information may be determined in such a manner that the displayed information is of particular interest to the individual.

Base unit 101 may include manual inputs 102. Typically the manual inputs 102 for a video telephone include a standard telephone keypad with ten numeric buttons plus a “#” and “*” buttons. Manual inputs may further include any number of other button switches, thumb wheels, pointing devices or other appropriate manual input devices. A wide variety of functions and features may be controlled using the manual inputs 102. Manual inputs 102 may include navigation keys or a joy stick for up, down, right and left selections and programmable soft keys. Power and status LEDs may also be provided to display information to a user.

A base unit 102 may be connected to a handset 104. Handset 104 may be substantially a standard telephone handset including a microphone and speaker. Handset 104 may be directly connected to the base unit 101. A handset 104 directly connected to the base unit 101 may be called a “tethered” or “wired” handset. Handset 104 may also include a wireless transceiver, a wireless connection to the base unit 101 including (or connected to) a wireless transceiver. The wireless transceivers may be a 2.4 GHz transceiver or any other suitable wireless transceiver frequency. The wireless transceivers may be spread spectrum transceivers. A handset 104 wirelessly connected to the base unit may be called a wireless handset.

Base unit 101 is connected to an interface 105. Typically, interface 105 is integral with base unit 101. Interface 105 includes an interface for connection to a network 106 such as an IP network. The network 106 may comprise an open network such as the Internet. Interface 105 includes interface connections 101 for connecting the base unit 101 to a variety of peripherals or networks. Typically, the interface 105 will provide Ethernet ports, telephone handset and keypad support, video capture and display ports including NTSC composite input and output ports, S video ports, NTSC camera ports and LCD display ports. The interface 105 may include audio capture and reproduction ports, an external microphone port, an external speaker port, two audio line level inputs, and a hands-free speaker phone.

A digital video camera 115 is connected to the base unit 101. Typical digital video camera 115 comprises a CCD camera device. The digital video camera 115 may be integral with the base unit 101 or the display 103. An additional digital video camera 137 may be integral with the handset 104. A privacy shield 141 may be a cover provided to disable the digital video camera 137 by covering the lens of the digital video camera 137.

Referring now to FIG. 2, a more detailed description of the components that may be incorporated into the handset 104 is illustrated. The handset 104 typically includes a speaker 135 and a microphone 136 to provide standard audio communication. Handset 104 may include a digital video camera 137, typically at one end of the handset 104. A scanner 138 may be provided on the handset 104 to read machine readable codes or scan image data. An LCD display 139 may be provided on the handset 104 to allow the user to see the input from the digital video camera 137, or show video data being displayed on display 103 when the handset 104 is being used remotely from the base unit 101. The handset display 135 may also show alternate visual data. The handset 104 may further include manual inputs 140 to control the video camera 137, hand display 139 and scanner 138.

Referring now to FIG. 3, there is illustrated an overall functional block diagram of a basic broadband information appliance 100. A gateway 110 provides an interface to a network 106. In a preferred embodiment, the network is an IP network such as the Internet. The gateway 110 communicates with voice over Internet protocol (VOIP) hardware 111 and video hardware 114. The voice over IP hardware 420 provides all of the voice and audio functionalities for the broadband information appliance 100. The video hardware 114 provides the video capabilities to the broadband information appliance 100 such as streaming video of a speaker or display of a browser for browsing the IP network such as the Internet. The voice over IP hardware 111 may be directly connected to a wired handset 104 or may be connected to a cordless base unit 112 which provides wireless communications with a cordless handset 113. The video hardware 114 may be connected to a video camera 115 and a display 103.

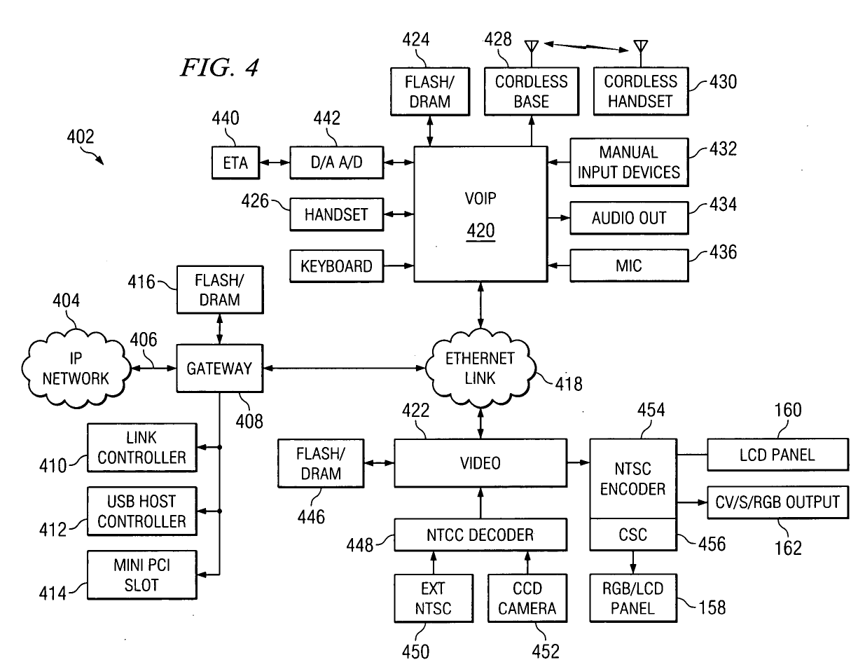

Referring now to FIG. 4, there is illustrated a detailed functional block diagram of an IP video telephone 402 that may more particularly comprise the broadband information appliance discussed above. The IP video telephone 402 is connected to an IP based network 404 through a connection 406. The interconnection 406 may be a wired connection such as a DSL connection or a cable connection through a DSL or cable modem, respectively. Alternatively, the interconnection 406 between the IP network 404 and the IP video phone 402 may comprise a wireless or satellite connection. The IP network 404 in the preferred embodiment comprises the Internet. However, any packet based network would be applicable to the following description. The IP video telephone 402 has its interface to the outside world and the IP network at a gateway processor 408. The gateway processor 408 provides communication with one or more networks 404. The gateway processor 408 typically acts as a master boot processor for the IP video telephone 402. The gateway processor 408 is typically an integrated, multiport PCI bridge system on a chip. In one embodiment, the gateway processor 408 comprises a Micrel KS 8695P processor. The KS 8695P integrates an ARM 922T CPU, a PCI bridge that can support up to three external PCI masters and a five port switch with integrated media access controllers and low power Ethernet PHYs. The PCI interface can be connected gluelessly to many PCI or card bus wireless LAN cards that support 802.11A/G/B. Those skilled in the art will recognize that other processors, chips or configurations could be used for the gateway processor 408.

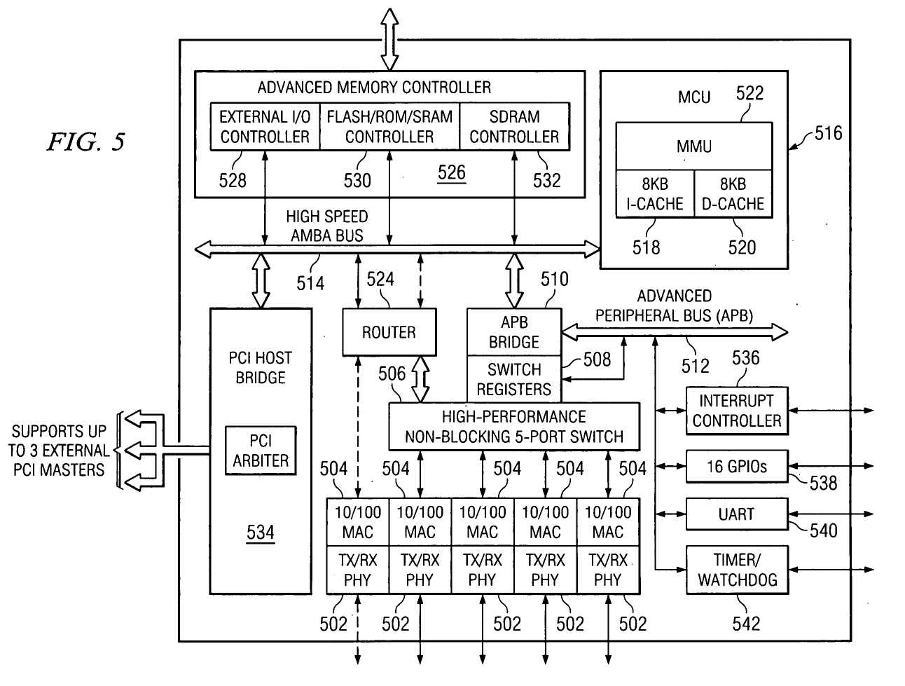

Referring now to FIG. 5, there is provided a functional block diagram of the gateway processor 408. The gateway processor 408 includes a plurality of transmit/receive PHY transceivers 502 enabling communications to and from the gateway processor 408. The transceivers 502 are mixed signal, low powered, fast Ethernet transceivers and have corresponding media access control units 504 associated therewith. A switching engine 506 moves data to and from the MACs 504. The switching engine 506 operates in a store and forward mode. Associated with the switch engine 506 are switch registers 508 and an APD bridge 510 for interconnecting the advanced peripheral bus (APB) 512 with the high speed AMBA bus 514. A microcontroller unit 516 controls operation of the gateway processor 408. The microcontroller unit 516 operates at 166 MHz and includes an 8 kilobyte I-cache 518 and an 8 kilobyte D-cache 520. A memory management unit 522 enables operation with Linex and WinCE®. A router 524 assists in the processing of packets transmitted by the gateway processor 408.

An advanced memory controller 526 includes an external input/output controller 528, a flash/ROM/SRAM controller 530 and an SDRAM controller 532. These controllers provide programmable 8/16/32 bit data and 22 bit address bus with up to 64 megabytes of total memory space for flash, ROM, SRAM, SDRAM and external peripherals. The PCI host bridge 534 supports three external PCI masters or guest mode and further a mini PCI and card bus peripheral. The PCI host bridge 534 supports a 33 MHz, 32 bit PCI interface. The gateway processor 408 further includes an interrupt controller 536 for generating interrupts in response to various interrupt conditions, 16 GPIOs for inputting and outputting data, a UART transceiver 540 and timer/watchdog circuitry 542 for timing various events.

Referring now back to FIG. 4, there are illustrated a link controller 410, USB controller 412 and mini PCI slot 414 connected to the gateway processor 408 via the PCI bridge 534. Likewise, the FLASH DRAM memory 416 is connected to the gateway processor 408 through the advanced memory controller 526. An Ethernet link 418 provides for interconnection between the gateway processor 408, a voice over IP processor 420 and a video processor 422. The voice over IP processor 420 is a communication processor providing audio, Codec and telephone management. In one embodiment, the VOIP processor 420 may comprise a teleology TNETV105 DSP.

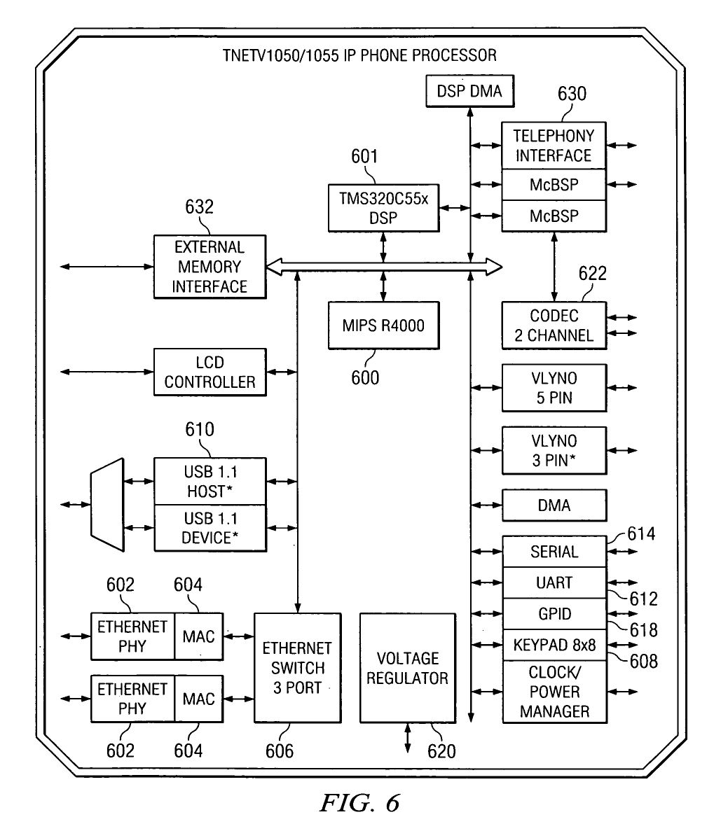

Referring now to FIG. 6, there is more fully illustrated one embodiment of the VOIP processor 408. Two 10/100 base T Ethernet PHY 602 and MAC 604 transceivers are included with an integrated layer to three port Ethernet switch 606. On-chip peripherals include an 8×8 keypad interface 608, a USB controller host 610, a UART serial interface 612, a programmable serial port 614 enabling serial port communications and a general purpose input/output interface 616. An integrated voltage regulator 620 provides for voltage regulation with respect to the VOIP processor 420. An integrated dual channel 16-bit voice codec integrates the coding/decoding functions necessary for IP phone applications and includes two analog-to-digital converters and two digital-to-analog converters. Other codec features include analog and digital side tone control, antialiasing filter, programmable gain options and programmable sampling rate. Other features of the VOIP processor 420 include analog-to-digital side tone control, filter, programmable gain options, programmable sampling rate, 8-bit speaker driver, microphone, and handset and headset interface 630.

The TNETV 1050 VOIP processor is a communications processor based on a MIPS 32 reduced instruction set computer (RISC) processor 600, along with a C55X digital signal processor (DSP) 601. The VOIP processor 420 has a rich peripheral set architect specifically for IP phone applications, which reduced the build materials costs, time and complexity associated with developing an IP phone. The RISC processor 600 supplies the overall system services and performs user interface, network management, protocol stack management, call processing and task scheduling functions. The DSP processor 601 provides real time voice processing functions such as echo cancellation, compression, PCM processing and tone generation/detection.

The external memory interface 632 supports two SDRAM chip selects providing 120 megabytes of memory space. The external memory interface 632 also supports three chip selects providing 16 megabytes each of RAM or ROM memory. Finally, the interface provides one chip select for providing a 32 megabyte flash memory.

Referring now back to FIG. 4, the VOIP processor 420 is connected to the flash/DRAM memory 424 through the external memory interface 632. The flash/DRAM memory 424 may comprise a flash memory, SDRAM or other suitable memory device. The VOIP processor 420 is also connected to a handset 426. The telephony interface 630 may also provide an interconnection for a cordless base 428 providing a wireless interconnection with a cordless handset 430. The voice over IP processor 420 may also be connected with a manual input device 432 to enable an individual to input information into the VOIP processor 420. Additionally, an audio out connection 434 provides for the ability to externally output audio information to the user of the IP video telephone 402. A microphone 436 enables the user to input audio information into the VOIP processor 420.

An embedded terminal adaptor 440 is interconnected with the VOIP processor 420 through a digital-to-analog and analog-to-digital interface 442. Information transmitted from the embedded terminal adaptor 504 is converted from analog into digital data by an analog-to-digital converter within the interface 442. Likewise, digital data coming from the VOIP processor 420 is converted into analog data for use by an analog telephone connected to the embedded terminal adaptor 440 by the interface 442. Information provided to the VOIP processor 420 by an analog telephone connected to the embedded terminal adaptor 440 is routed from the VOIP processor 420 to the gateway processor 408. The gateway processor 408 allows the data to be packetized and transmitted over the IP network 404 such that ultimately the data can be routed to another VOIP device connected to the IP network 404 or to an analog telephone connected to a PSTN network which is interconnected to the IP network 404.

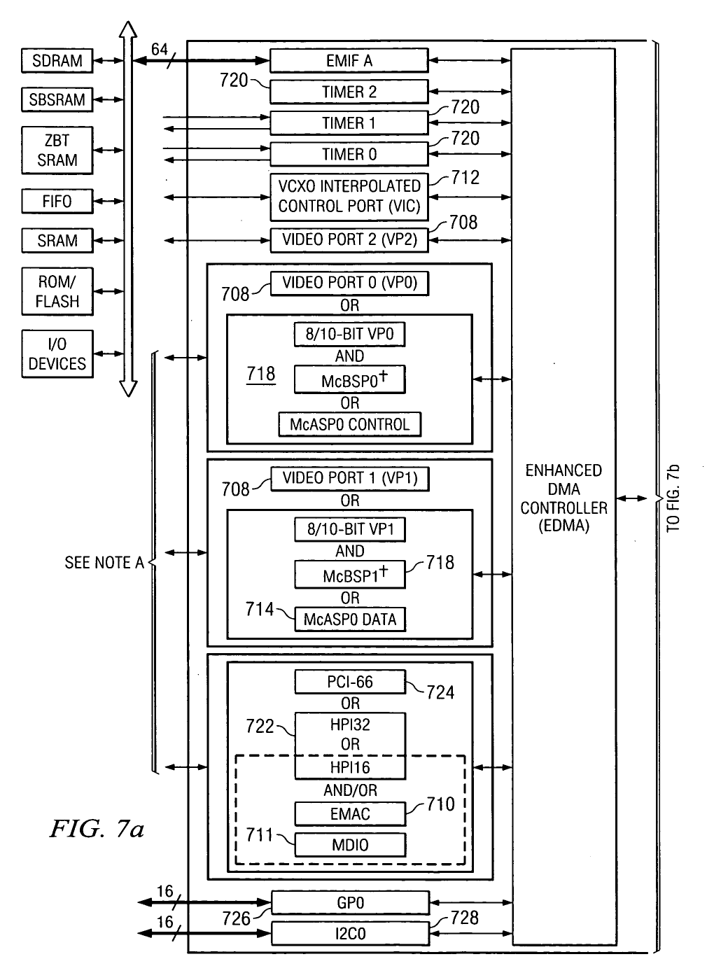

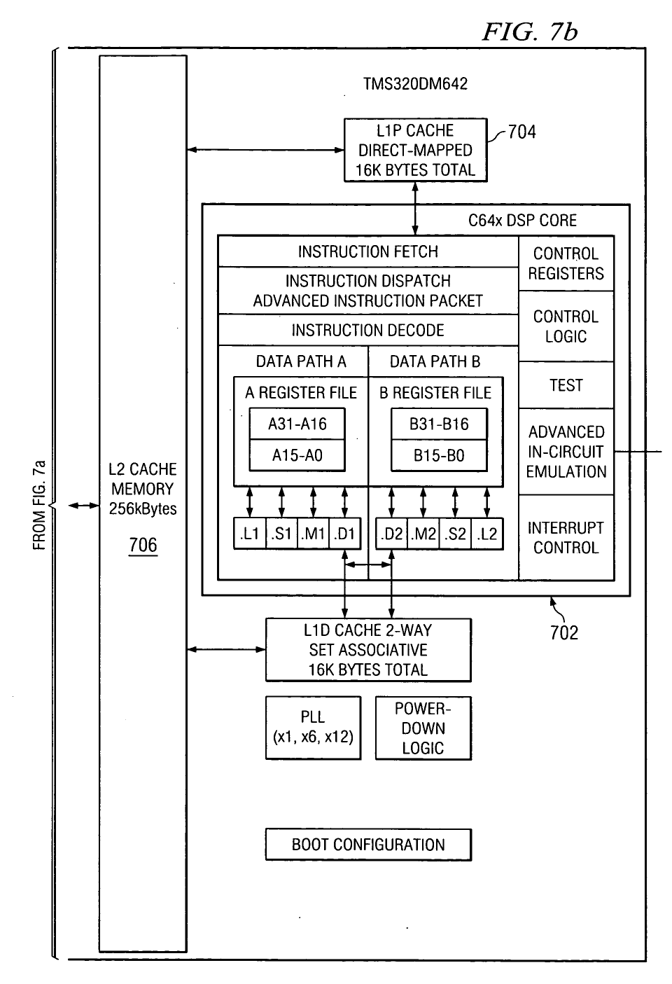

The video processor 422 is connected to the Ethernet link 418 to provide video capabilities for the IP video telephone 402. The video processor 422 includes a video Codec and LCD panel controller. The video processor 422 may in one embodiment comprise a TI TMS320DM642 digital signal processor. Referring now to FIG. 7, there is illustrated a functional block diagram of one embodiment of the video processor 422. The digital signal processor is based on the second generation high performance advance velociTI very long word instruction (VLIW) architecture. The digital signal processor may provide 4800 million instructions per second at a clock rate of 600 MHz. The DSP offers the flexibility of high speed controllers, and the numerical capability of array processors. A DSP core processor 702 has 64 general purpose registers of 32-bit word link and six arithmetic logic units. The DSP provides extensions in the eight functional units including new instructions to accelerate performance in video and imaging applications to extend parallelism. The DSP can produce four 32-bit multiply accumulates per cycle for a total of 2400 million MACs per second or eight 8-bit MACs per cycle for a total of 4800 million MACs. The DSP may have application specific hardware logic, on-chip memory and additional on-chip peripherals. The DSP typically uses a two level cache based architecture. A level one program cache 704 is a 128K bit direct mapped cache and a level one data cache is a 128-Kbit direct mapped cache and a Level 1 data cache is a 128-Kbit 2-way set-associative cache. A Level 2 memory cache 706 consists of a 2-Mbit-memory space that is shared between program and data space. Level 2 memory can be configured as mapped memory. Those skilled in the art will recognize that other DSP processors may be implemented.

The video processor 422 includes three configurable video port peripherals 708 (VP0, VP1 and VP2). These video port peripherals provide a glueless interface to common video decoder and encoder devices. The DSP video port peripherals support multiple resolutions and video standards. The video ports peripherals are configurable and can support video capture and video display modes. Each video port may include two channels with a 5120 byte capture/display buffer that is split-able between the two channels. The DSP video ports include a capture port interfaced with a Philips decoder with integrated multiplexer for NTSC, S-video sources; a display port interfaced with Philips SAA7105 NTSC and S-video encoder and a third port dedicated to the LCD panel.

The peripheral set further includes a 10/100 Mb/s Ethernet MAC; a management data input/output 711; a VCXO interpolated control port 712; a multichannel buffered audio serial port 714; an inter-integrated circuit bus module; two multichannel buffered serial ports 718; three 32-bit general purpose timers 720; a user-configurable 16-bit or 32-bit host port interface 722; a peripheral component interconnect 724; a 16-bit general-purpose input/output port 726 with programmable interrupt/even generation modes; and a 16-bit glueless external memory interface 728 which is capable of interfacing to synchronous and asynchronous memories and peripherals.

The multichannel buffered audio serial port transmitter 714 is programmed to output multiple encoded data channels simultaneously with a single RAM containing the full implementation of user data and channel status field. The multichannel buffered audio serial port 714 also provides extensive error checking and error features, such as bad clock deterioration circuit for each high frequency master clock which verifies that the master clock is within a program frequency range.

The Ethernet media access controller 710 provides an efficient interface between the DSP core processor and the Ethernet network 418. The media access controller 710 supports both 10-base T and 100-base T in either have or full duplex with hardware flow control and quality of service support. The Ethernet MAC 710 makes use of a customer interface to the DSP core that allows efficient data transmission and reception.

The management data input/output (MDIO) module 711 continuously pulls all 32 MDIO addresses in order to enumerate all PHY devices in the system. Once a PHY candidate has been selected by the DSP, the MDIO module transparently monitors its link state by rating the rating the PHY status register. Link change events are stored in the MDIO module 711 and can optionally interrupt the DSP, allowing the DSP to pull the link status of the device without continuously performing costly MDIO accesses.

The VCXO interpolated control (VIC) 712 port provides a digital-to-analog conversion with resolution from 9-bits to up to 16-bits. The output of the VIC 712 is a single bit interpolated D/A output.

The I2C0 port 728 on the video processor 422 enables the DSP to easily control peripheral devices and communicate with a host processor. Additionally, the standard multichannel buffered serial port (MCBSP) 718 may be used to communicate with serial peripheral interface (SPI) mode peripheral devices.

The video processor 422 connects with a video memory 446. The video memory 446 may comprise a flash memory, SDRAM, or other suitable memory device. The video processor 422 also connects to a video decoder 448. The video decoder may comprise an NTSC decoder for decoding provided video data. The video decoder 448 receives video signals from an external NTSC source 450 or from a video camera 452. The video processor 422 is also connected with a video encoder 454 that may comprise an NTSC encoder. The video encoder 454 may be integral with a CSC 156 to provide video signals to a RGB/LCD panel 158. The video encoder 454 may also provide video signals to an LCD panel 163 and a CV/S/RGB output 162.

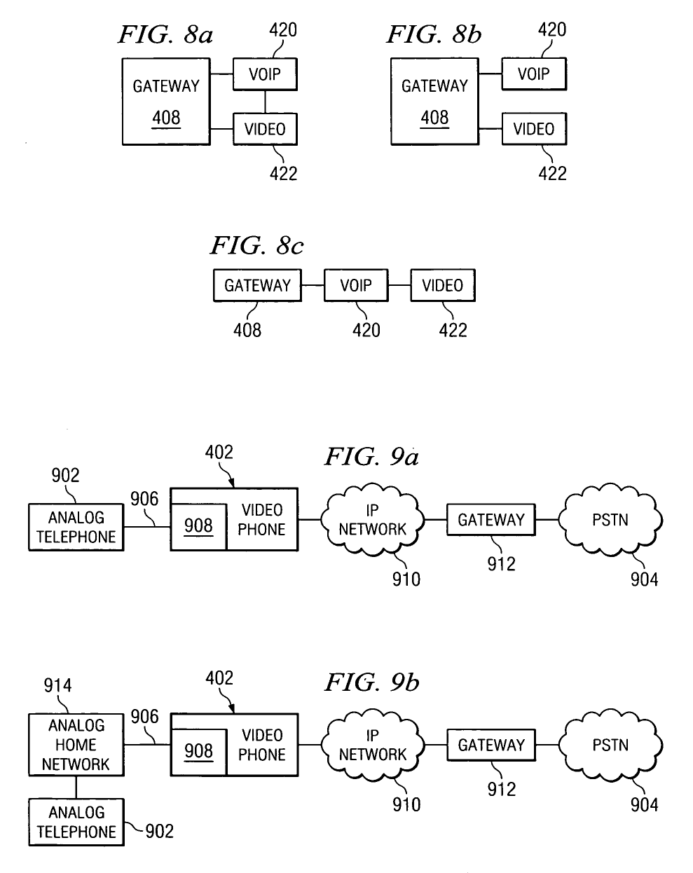

Referring now to FIG. 8a-8c, there is more fully illustrated the flexibility provided by the use of a gateway processor 408, VOIP processor 420 and video processor 422 that are able to communicate via an Ethernet network on a same board. FIG. 8a illustrates a first configuration of the gateway processor 408, voice over IP processor 420 and video processor 422. Each of these processors are included upon a same device board within the IP video telephone. In this configuration, each of the processors has an Ethernet connection with each of the other processors. Thus, the gateway processor 408 may communicate directly with the voice over IP processor 420 and the video processor 422. Also, the voice over IP processor 420 may communicate with each of the gateway processor 408 and the video processor 422, and finally, the video processor 422 may communicate with each of the gateway processor 408 and voice over IP processor 420.

FIG. 8b illustrates a configuration wherein only the gateway processor 408 may communicate with each of the voice over IP processor 420 and the video processor 422. When the video processor wishes to converse with the voice over IP processor 420, it must do so through the gateway processor 408. Thus, IP packet messages are transmitted from the video processor 422 to the gateway processor 408, and the gateway processor 408 then forwards the IP packets to the voice over IP processor 420. Likewise, when the voice over IP processor 420 desires to communicate with the video processor 422, it must forward packets to the gateway processor 408 which then forwards the packets onward to the video processor 422. As can be seen, each of the voice over IP processor 420 and video processor 422 may communicate directly with the gateway processor 408.

Finally, FIG. 8c illustrates a chained configuration wherein the gateway processor 408 communicates only with the voice over IP processor 420. The voice over IP processor 420 can communicate with either of the gateway processor 408 and the video processor 422. The video processor 422 only communicates with the voice over IP processor 420. All packets transmitted from the gateway processor to the video processor must be transmitted through the voice over IP processor 420, and likewise, all packets transmitted from the video processor 422 to the gateway processor 408 must be routed through the voice over IP processor 420.

The use of processing devices on the same board having packet network communications functionalities associated therewith enables an ease of configuration and updating with respect to the IP video telephone board. In this configuration, any of the processing chips used for either the voice over IP processor 420, gateway processor 408 and video processor 422 may be upgraded to a different chip or component by merely implementing the new chip within the board design. The only requirement is that the newly implemented chip must have the ability to transceive over an Ethernet network. Since the processors within the IP telephone board are each designed to carry out their various functionalities and communicate with the outside world using IP packets via an IP network, the use of differing components for these processors does not adversely affect the operation of the IP video telephone board.

Referring now to FIGS. 9a and 9b, there are illustrated the manners in which an analog telephone may be both connected to the PSTN network 904 through an IP video telephone 402. In this embodiment, the analog telephone 902 connects with the IP video phone 402 through an analog connection 906. The analog telephone 902 is plugged into the IP video telephone 402 at an embedded terminal adaptor 908. Embedded terminal adaptor 908 enables the IP video telephone 402 to accept analog signals from the analog telephone 402 and convert them into digital IP packet data that may be used to transmit over the IP network 910 to the PSTN network 904. The IP network 910 is connected to the PSTN network 904 through a gateway 912.

Referring now to FIG. 9b, there is illustrated an alternative embodiment wherein the analog telephone 902, rather than being plugged directly into the IP video telephone 402, is plugged into an analog home network 914. Rather than plugging the analog telephone 902 directly into the embedded terminal adaptor 908, the analog home network 914 is plugged into the embedded terminal adaptor 908. In this manner, analog telephones 902 within a home may be plugged into the existing telephone jacks of the home since the analog home telephone network is no longer directly connected to the PSTN network 904 but is instead connected to the IP video telephone 402. Signals generated by the analog telephone 902 are transmitted over the analog home network 914 to the IP video telephone 402 through the embedded terminal adaptor 908. These signals are converted to IP packet signals and provided over the IP network 910 to the public switched network 904 or other IP video phones connected to the Internet.

When connected in the manners illustrated in FIGS. 9a and 9b, the analog telephone 902 will operate as it normally does when connected with the PSTN network 904. The connection to the PSTN network 904 through the IP network 910 via the IP video telephone 402 is seamless to the user of the analog telephone 402.

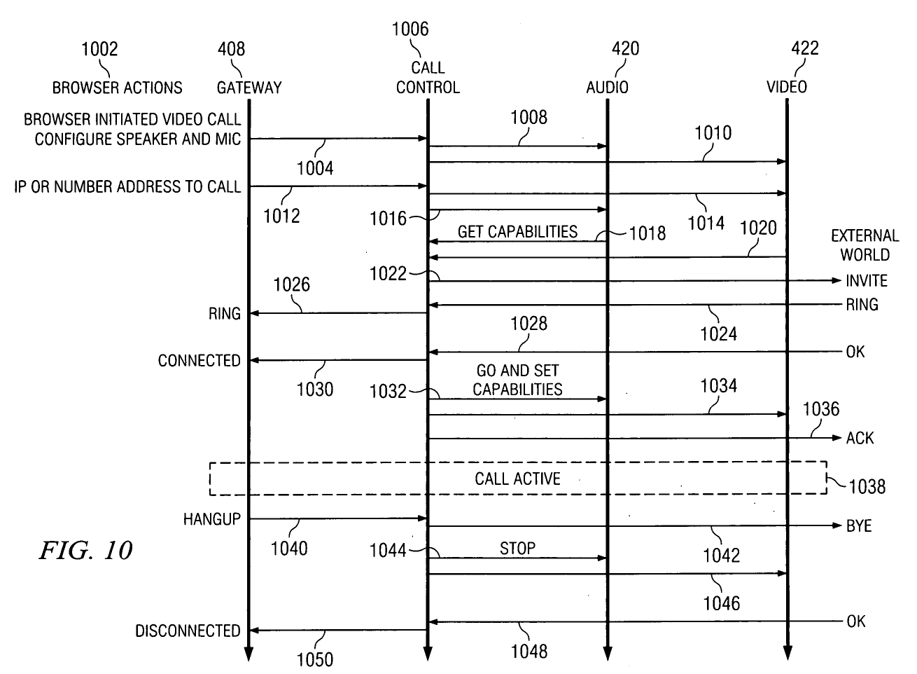

Referring now to FIG. 10, there is illustrated the process for providing a call connection and call disconnection using the IP video telephone of the present disclosure. Initially, a browser 1002 initiates a call by transmitting a message 1004 to call control 1006. The call control 1006 transmits a message 1008 to the audio processor 420 to configure the audio processor protocol. The call control 1006 also transmits a message 1010 to the video processor 422 to configure the video processor for operation. The gateway 408 provides the IP address or number address for the call at 1012. This information is provided to the video processor 422 at 1014 and to the audio processor 420 at 1016. The audio processor 420 provides the ability to provide audio support for the call at 1018, and the video processor 422 provides the capabilities for video processing for the call at 1020. The call control 1006 initiates the call to the external world at 1022.

A ring signal 1024 is provided from the external world back to the call control and the call control forwards the ring signal to the gateway processor and the call control 1000 forwards the ring signal to the gateway processor 408 at 1026. After the call is answered at the receiving end, an answer signal 1028 is provided from the external world to the call control 1006. The call control 1006 notifies the gateway 408 that the call is connected using a call connection signal 1030. The call controller 1006 notifies the audio processor 420 at 1032 that the call is connected and sets the capabilities for the call with the audio processor. The video processor 422 is notified at 1034 that the call is connected and sets the capabilities for the video processor 422. The call control 1006 transmits an acknowledge signal 1036 back to the external world to where the call has been answered. The call is supported by the IP video telephone during the time period 1038 for which the call is active.

Once the user has completed the call and hangs up the receiver of the IP video telephone, a hang-up signal 1040 is provided from the gateway 408 to call control 1006. The call control 1006 initiates a hang-up notification 1042 to the external world to the unit to which the IP video phone is connected. The call control 1006 initiates a stop signal 1044 to the audio processor 420 and a stop signal 1046 to the video processor 422 to indicate that the call has been disconnected. An acknowledgment 1048 is received from the external world at the call control 1006, and the call control notifies the gateway processor 408 that the call is disconnected at 1050.

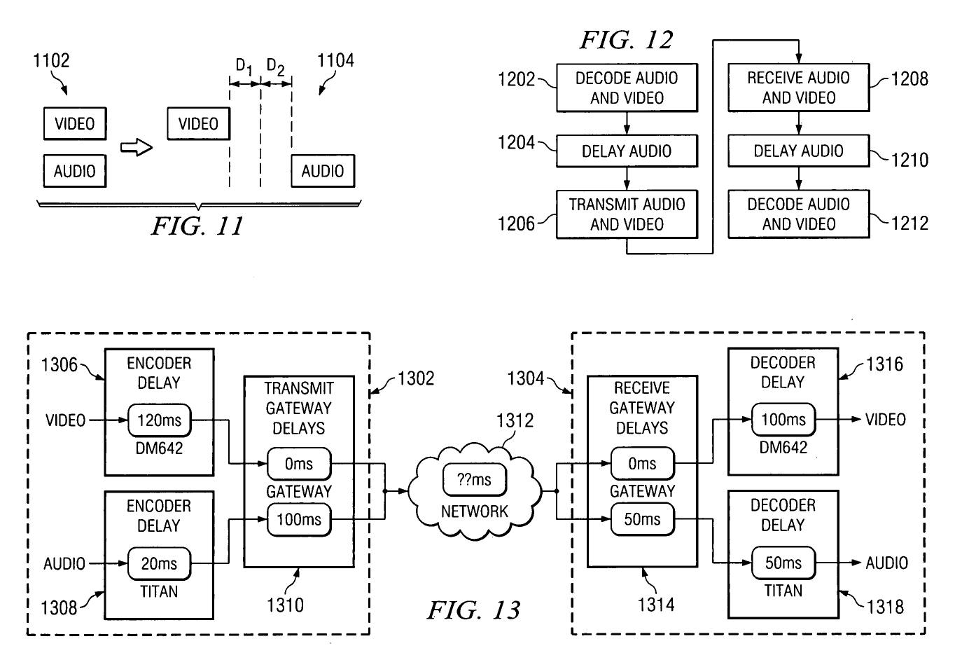

Referring now to FIG. 11, there is illustrated the problem of synchronization associated with the transmission of associated audio and video packets from a video phone at first location 1102 to a video phone at second location 1104. The video and audio encoding of the video and audio packets begins at the same time, and the packets are transmitted as the audio and video encoding are completed over an IP packet network such as the Internet. Decoding of the audio and video packets is begun upon receipt of said packets at the second location 1104. The process begins with the video and audio packets synchronized at location 1102. The packets will become unsynchronized by the time they arrive at location 1104 with the audio packets arriving for provision to a third party much sooner than the video packets. This is due to the inherent delays associated with the encoding/decoding of the video packet at both the first location 1102 and the second location 1104. The encoding of video packets at location 1102 takes longer than the encoding of audio packets. Thus, if the audio packets and video packets are transmitted as soon as they are ready, the audio packets will be transmitted prior to the video packets since the video packets will take longer to encode.

During transmission of the packets over the IP network, the assumption is that the packets sent at the same time will be grouped together as they are received and arrive at substantially the same time. However, when arriving at the second location 1104, the decoding of the video packet will again take longer than the decoding of the audio packet at the second location. Thus, the initial delay D₁ between the audio and video packets is caused by the encoding delays at the first location 1102 and the second delay D₂ is associated with the inherent decoding delay differences between the audio and video packets. Thus, a total delay of D₁+D₂ will be introduced between the audio and video packets resulting in a lack of synchronization between the audio and video packets at the receiving end.

One manner for minimizing or eliminating the lack of synchronization between the audio and video packets is illustrated in the flow chart of FIG. 12. The decoding of both the audio and video packets is begun at step 1202 with each of the associated audio and video packets being encoded in their normal fashion. However, once received at the gateway processor, the audio packets are delayed at step 1204 to an amount equal to the difference in the length of time it takes an audio packet and a video packet to be encoded. The received video packets and the delayed audio packets are transmitted at step 1206 to a second location 1104 from the first location 1102. The packets, both audio and video, are received substantially together at step 1208 at the second location 1104, and the audio packets are again delayed at step 1210 by an amount equal to the difference between the amount of time required to decode the audio packet from the amount of time to decode the video packet. The undelayed video packets and the delayed audio packets are decoded at step 1204 such that the completed decoding of associated packets will be provided at substantially the same time due to the delay introduced at the processing gateway of the receiving IP video telephone at location 1104. The introduced delay at the transmitting and receiving ends will cause the audio and video packets to be substantially synchronized.

Referring now to FIG. 13, there is more fully illustrated this process with respect to a pair of IP video telephones 1302 and 1304. The video to be encoded is input to the video processor 1306. The audio to be encoded is input to the audio processor 1308. The delay caused by the encoding is 20 milliseconds for the audio processor 1308 and 120 milliseconds for the video processor 1306. When these decoded packets are received at the gateway 1310, the audio packets are delayed by 100 milliseconds and the video packets are not delayed at all. This is due to the difference in delays associated with the encoding of the audio and video data. In this manner, associated audio and video data packets will be transmitted from the transmit gateway 1310 at substantially the same time.

The packets are transmitted over the associated IP network 1312 and statistically the packets will take the same pathway and arrive at a receive gateway 1314 at substantially the same time. The audio packets received at the receive gateway 1314 are delayed for 50 milliseconds while the video packets are not delayed at all and are passed on directly to the video decoder 1316. The provided video packets are decoded by the video decoder 1316 which takes approximately 100 milliseconds. After a delay of 50 milliseconds, the associated audio packets are forwarded to the audio decoder 1318 wherein the packets are decoded in approximately 50 milliseconds. Due to the induced delay of 50 milliseconds at the receive gateway 1314 for the audio packets, the audio packets provided from the audio decoder 1318 and the associated video packets from the video decoder 1316 will be output as associated video and audio packets at substantially the same time. This provides for a synchronized output at the IP video telephone 1104.

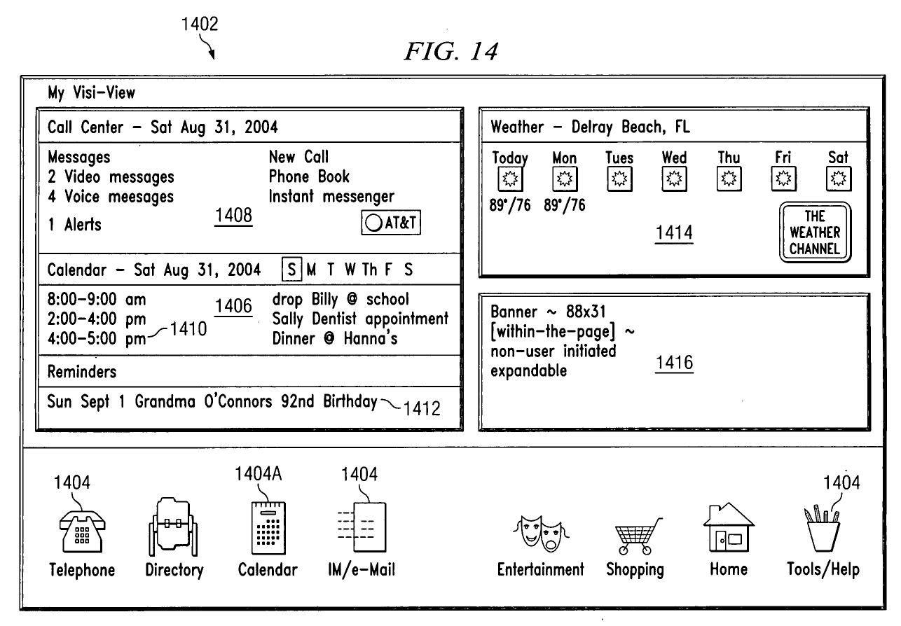

Referring now to FIG. 14, the IP video phone main display 1402 allows a user a quick and easy access to selection key applications each are which associated by a single touch button represented by a number of icons. The eight soft coded buttons 1404 that appear below the active display area 1406 correspond to specific activities or applications denoted by small icons that appear within the active display. For example, if a user selects and depresses the calendar button 1404a this will cause the IP video telephone to load and display a calendar application. The small icons on the bottom of the active display panel will vary depending upon the specific page or application that is selected by a user. As a result, each soft coded button 1404 will trigger or launch a specific and different activity or application relative to which active page or application is displayed. For example, if the user selects and depresses the button 1404a that corresponds to the calendar, this will result in loading the calendar application or load a web page that displays a user's personal calendar. When the calendar application is active, the icons that correspond to each of the buttons may differ than those as they appear in FIG. 14. The icons that would appear in the active calendar application would be relevant to the calendar application itself which will be more fully described hereinbelow.

The active display 1406 provides various information to the user. A message portion 1408 provides an indication of stored voice and video messages to the user. The calendar portion 1410 provides an abbreviated version of the user's calendar for the day and the ability to select a particular day of the week to view activities scheduled for that day. A reminders section 1412 provides various reminders that the user has programmed into the IP video telephone enabling them to be reminded of particular events or appointments. A weather display 1414 provides various information to the user on current and coming weather conditions for various days of the week. Finally, an ad window 1416 provides for the placement of banner ads that have been purchased by various advertisers that have a business relationship with the service provider of the IP video telephone. While the foregoing description describes one particular embodiment of the display associated with the IP video telephone, it will be realized by one skilled in the art that the above-described displays and the particular descriptions of the displays following herewith comprise only a single embodiment and numerous changes and alterations to the display may be made to suit a particular user and/or service provider.

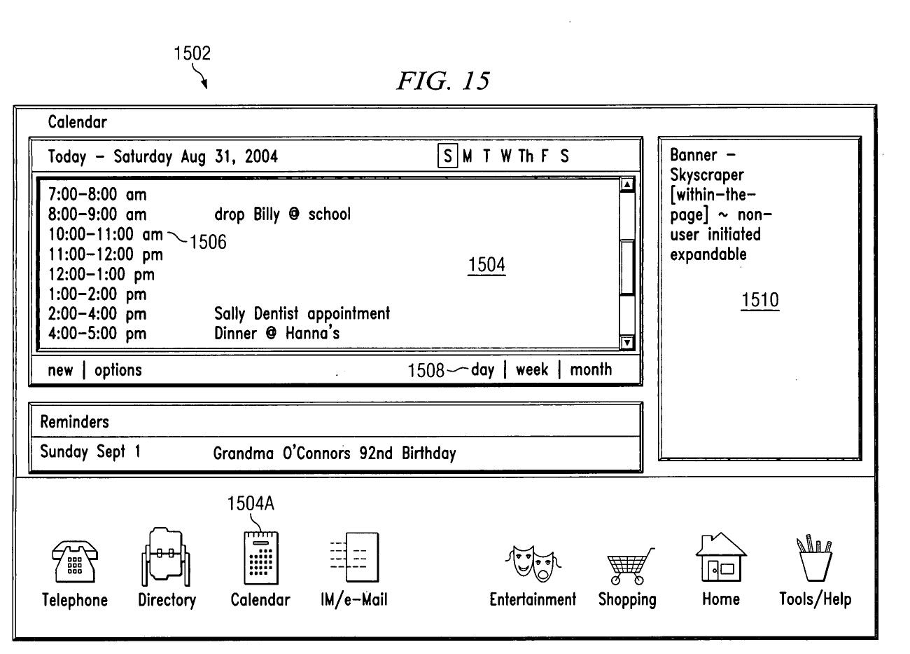

Referring now to FIG. 15, the calendar display screen 1502 provides a user with more detailed calendar information as well as enables the user to add, edit or view various individual family members' calendars. Users will have the ability to upload and download personal calendars form external sources and devices including, but not limited to, PDAs, Microsoft Outlook and Eudora. Users would also have the ability to view their personal calendars stored within the IP video telephone away from the IP video telephone as long as they have access to an Internet connection and a web browser. The active display 1504 associated with the calendar button 1404a includes a screen displaying the calendar items for today. The calendar includes options 1508 for displaying a day, week or month configuration on the calendar and an advertisement window 1510 enables banner ads to be displayed to the IP telephone user.

Referring now to FIG. 16, the telephone display screen 1602 is displayed responsive to pressing the telephone display button 1504b. The telephone display screen 1602 allows a user an overall view and access to call center applications including call log, audio and video messages, directories and telephone listings, alert notifications and the IP telephone's dial pad to make a telephone or video call. Text within the call log pane 1604, message pane 1606 and directory pane 1608 are hot linkable. A user is able to drill down and view more detailed information within the selected window panes by simply using a tethered stylis and touching a respective hot link. For example, if a user selects and touches “Receive Calls” hot link in the call log window pane 1604, the user will be able to review all of the received calls that have been stored within the memory of the IP video telephone.

The call log pane 1604 additionally provides information on previously dialed calls and missed calls. The messages pane 1606 provides listing of both video and voice messages that have been received and stored for a user. The directories pane 1608 provides access to various telephone directories including a personally created phone book, a white pages or a yellow pages. An alerts pane 1610 may provide either information previously indicated by the user as important to the user for which they wish to wish alerts upon, or alternatively, may be directed information pushed to the user based upon data mining analysis with respect to the user's call and/or interest activities.

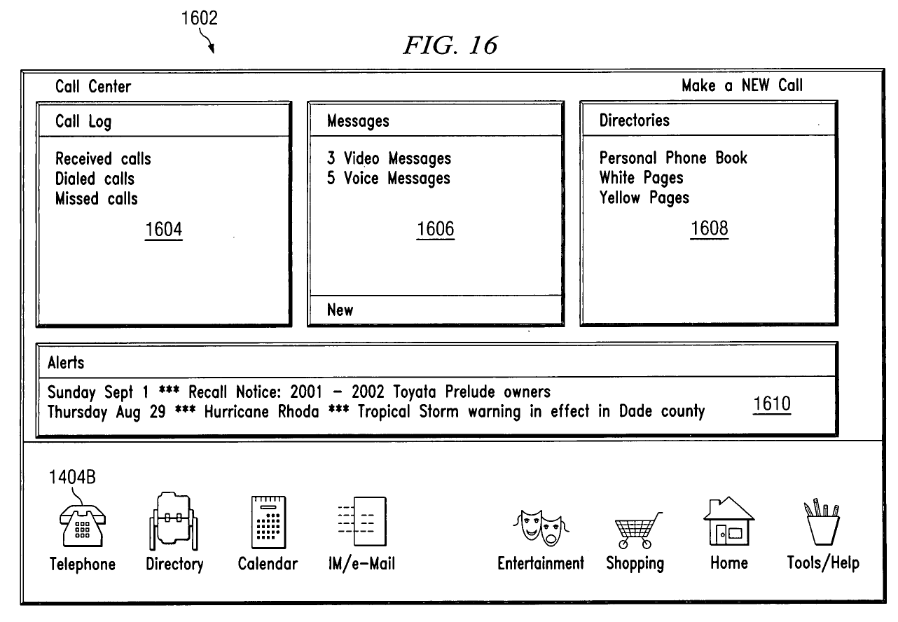

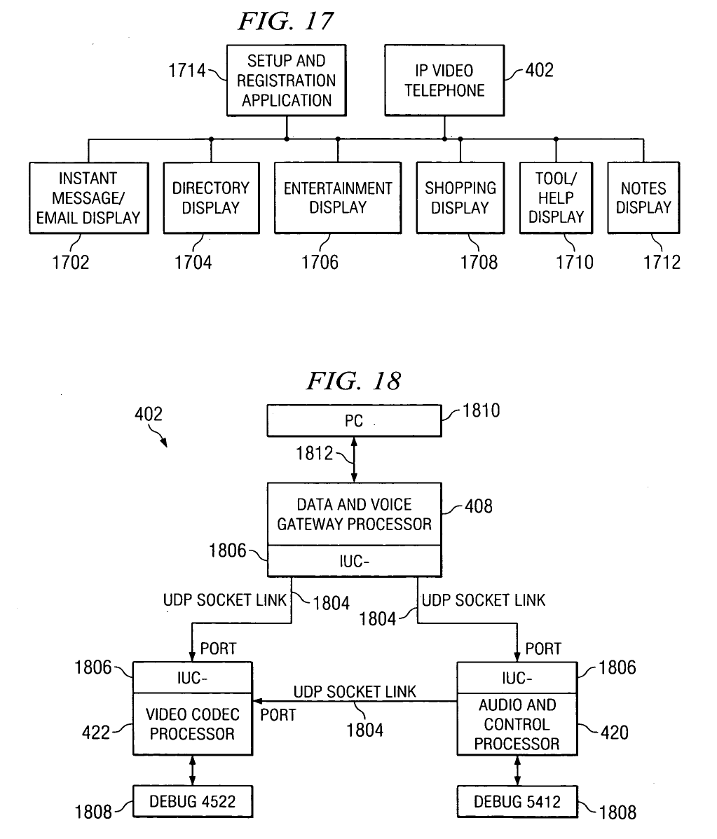

In addition to the displays described above, the IP video telephone may also include the displays illustrated in FIG. 17. The instant message/email display 1702 enables the video phone 402 to display instant messaging messages and email messages. Additionally the instant message/email display 1702 enables the creation of these kinds of messages. The directory display 1704 provides a listing of all telephone numbers that a user has stored for point and click dialing or may provide network access to publically available directories. The entertainment display 1706 displays various entertainment content that an IP telephone user has either has programmed in themselves or has been determined to be of interest to the user by a host server providing service to the IP video telephone 402. The shopping display 1708 displays various content providers that a user has indicated an interest in shopping from or displays content providers than the host server has determined a user may have an interest in shopping from the provider. The tool/help display 1710 provides an interface enabling a user to solve various problems or receive how to descriptions for the video telephone. The display 1710 includes a search screen enabling a user to search available information and a index screen with an index of available information. The notes display 1712 provides a display enabling users to leave messages or reminders to themselves or another. A note display icon may be displayed responsive to an open note. The setup and registration application display 1714 provides a user with the ability to setup and register their IP video telephone 402 with the network and a host server. Relevant information and system parameters are entered through this display.

Referring now to FIG. 18, there is illustrated a block diagram describing the manner in which the data and voice gateway processor 408, the video codec processor 422 and the audio VOIP processor 420 may carry out inter unit communications (IUC) between each of the associated devices. Communications between each of the data and voice gateway processor 408, video codec processor 422 and audio VFOIP processor 420 are carried out via UDP socket link connections 1804. Communications over the UDP socket links 1804 are enabled via IUC control software 1806 stored within each of the units. The video codec processor 422 and the audio VOIP processor 420 additionally include debugging functionalities 1808 to enable the debugging of communications problems within each of these devices. The data and voice gateway processor 408 may additionally communicate with an external PC 1810 via a communications link 1812. The IUC handler 1806 on each processor uses the TCP/IP socket communications protocol as the transport layer between the various devices. The IUC handler 1806 additionally statically initializes and builds the UDP port on specific applications. The IUC handler 1806 enables command and communications between the processors to be based upon a TEXT/ASCII string. Each IUC handler 1806 converts TEXT/ASCII strings to a hexadecimal command structure. The IUC handler's 1806 other functionalities include providing a clock signal to keep processors alive, provisioning data for transportation through IUC socket connections and providing pay load data through different claims. Interdevice communications use a local area network (LAN) Ethernet transport, TCP/IP protocol, and optionally may communicate via an onboard LAN card with an external PC 1810.

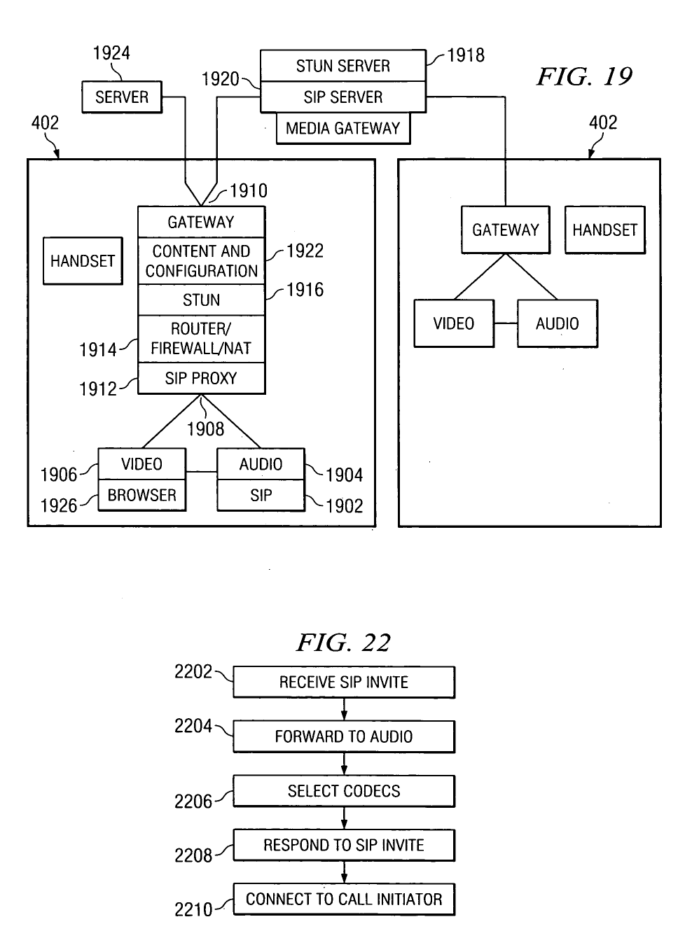

Referring now to FIG. 19, there is more fully illustrated a pair of IP video telephones 402 and the software modules associated therewith enabling call connections between a pair of IP video telephones 402 and enabling the provision of content to a display of the IP video telephone 402 via the Internet. As described previously, the video telephone 402 consists of the gateway processor 408, audio processor 422, video processor 420 and a telephone handset 104 providing a user interface with the functionalities of the video telephone 402. The audio processor 422 includes a SIP module 1902 enabling the video telephone 402 to set up calls over the Internet using a voice over IP functionality to carry out the calls. Calling between video telephones 402 is enabled via the SIP (session initiation protocol) protocol.

SIP is a signaling protocol for Internet conference, telephony, presence, event notification and instant messaging. SIP provides the necessary protocol mechanisms so that systems and proxy server can provide services such as call forwarding; callee and calling “number” delivery, where numbers can be any (preferably unique) naming scheme; personal mobility, i.e., the ability to reach a called party under a single, location independent address even when the user changes terminals; terminal type negotiation and selection wherein a caller can be given a choice how to reach the party such as via Internet telephone, mobile phone, an answering service, etc.; terminal capability negotiation; caller and callee authentication; blind and supervised call transfer; and invitations to multicast conferences. Extensions of SIP allow third party signaling such as quick to dial services, fully meshed conferences and connections to multipoint control units, as well as mixed mode and the transition between those. SIP addresses users by an email-like address and reuses some of the infrastructure of electronic mail delivery such as DNSMX records or using SMTPEXPN for address expansions. SIP addresses (URLs) can also be embedded in web pages. SIP is addressing neutral, with addresses expressed as URLs of various types such as SIP, H.323 or telephone (E.164). SIP is independent of the packet layer and only requires an unreliable datagram service, as it provides its own reliability mechanism.

The data port 1904 of the audio processor 422, the data port 1906 of the video processor 420 and the data port 1908 of the gateway processor 408 each have unique internal IP addresses associated therewith that are used only within the video telephone 402. These unique IP addresses are different from the IP address associated with the data port 1910 with which the IP video telephone 402 is connected with the external world from the gateway processor 408. In order for data packets to be transmitted between the audio processor 422 and the video processor 420 to the external IP network through the gateway processor 408. The Ethernet and SIP addresses used within the internal Ethernet network and over the external IP network must be translated. Thus, when data packets are transmitted to the gateway processor 408, the SIP proxy 1912 is responsible for converting the SIP protocol addresses from the address utilized by the audio processor 422 to the SIP protocol address used at the output of the gateway processor 408. The SIP proxy module 1912 additionally converts the address of video packets from the video processor 420 to the address of the output of the gateway processor 408. The SIP proxy 1912 additionally includes the capability for routing audio stream packets to/from the audio processor 422 and video stream packets coming to/from the video processor 420 at the same time. The SIP proxy 1912 achieves this by transmitting the video packets as a second audio stream of larger audio packets. The SIP proxy 1912 believes it is transmitting a second audio stream when in fact it is transmitting the stream of video packets from the video processor. The router/firewall/NAT 1914 is responsible for translating addresses from packets received from the audio processor 422 and the video processor 420 in the ethernet domain. The packets from the audio and video processors have the IP port addresses from the outputs of both the audio and video processors. The router/firewall/NAT 1914 converts the addresses of these output ports to the address of the output port 1910 of the gateway processor 408 at the Ethernet level.

The stun module 1916 is utilized to enable the gateway processor 408 of the video telephone 402 to determine the IP address by which the outside world views the video telephone. The stun module 1916 does this by transmitting messages to a stun server 1918 associated with the SIP server 1920 enabling call connections. The stun server 1918 transmits a response back to the stun module 1916 indicating the outside world's view of data from the IP video telephone 402.

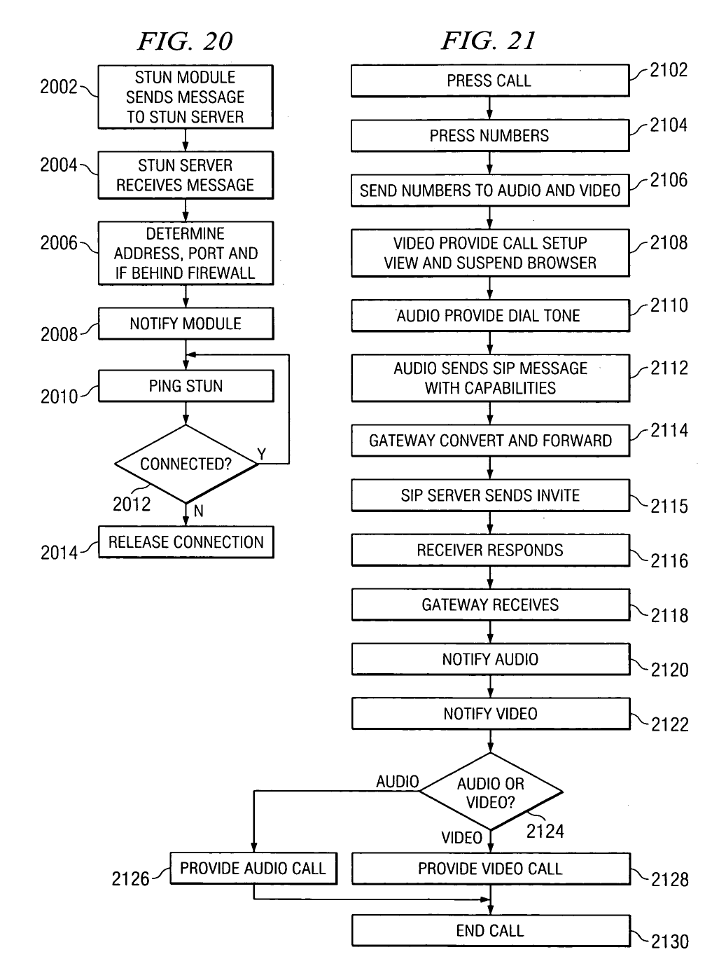

Referring now also to FIG. 20, there is more fully illustrated the manner in which the stun module 1916 is able to determine the way in which the outside world views the associated video telephone and in which the stun module 1916 provides an open port connection between the SIP server 1920 and a video telephone 402 by which an outside caller may connect to the video telephone 402. The stun module 1916 sends a message to the stun server 1918 at step 2002. The stun server 1918 receives at step 2004 the message from the stun module 1916 and determines at step 2006 the address associated with the video telephone 402 transmitting the stun server message, the port from which the stun server message is being transmitted and whether or not the data being transmitted from the video telephone is coming from behind a firewall. Responsive to this determination, the stun server 1918 notifies the stun module 1916 of its determinations at step 2008. Utilizing this information, the stun module 1916 periodically transmits messages to the stun server 1918 at step 2010 in order to maintain a connection between the video telephone 402 and the SIP server 1920. This periodic pinging to the stun server 1918 will continue as long as inquiry step 2012 determines that the video telephone is still connected to the network. Once inquiry step 2012 determines that the video telephone 402 is no longer connected, the connection is released at step 2014. The purpose for maintaining the connection between the stun server 1918 associated with the SIP server 1920 and the video telephone 402 is to enable incoming calls to be received by the video telephone. If the connection through the stun server were not maintained, the gateway processor 408 of the video telephone 402 would view an incoming message as an attempt to improperly access the gateway processor 408. By maintaining the connection between the stun module 1916 and the stun server 1918, the connection may be used to transmit incoming calls by transmitting SIP protocol messages over the connection to the gateway processor 408 of a receiving video telephone 402.

The content and configuration module 1922 enables control of the configuration of the audio processor 422 and the video processor 420. All operating parameters within these two processors are controllable through the content and configuration module 1922. One parameter the content and configuration module 1922 may set is the codec with which the audio and video processors process incoming and outgoing data packets. The audio processor may be configured to operate according to the G.711, G.722, G.720 or any other available audio codec with which the audio processor 422 may operate. Likewise, the video processor 420 may be configured to code/decode video packet data according to H.264, H.263 or other types of video codecs. In the preferred embodiment, the configuration parameters may be set within the content and configuration module 1922 from an external host server 1924. This external server may download these parameters into the content and configuration module 1922 and the content and configuration module 1922 may then download the appropriate parameters to the video processor 420 and the audio processor 422 through the internal ethernet.

The content and configuration module 1922 is also able to control the content which is displayed by the browser 1926 within the video processor 420. The browser 1926 operates as an Internet browser providing the ability for the video processor 420 to display various web page content upon the display of the video telephone 402. Content may be established within the content and configuration module 1922 either by the user of the video telephone 402 selecting display preferences or controlling browsing of the Internet through the browser 1926 using, for example, the handset 104. Alternatively, the external server 1924 may push content to the content and configuration module 1922 in order to enable external content providers to display, for example, directed advertising information on the browser 1926 of the video telephone 402. Thus, the content portion of the content and configuration module 1922 may be either controlled locally via the user of the video telephone 402 or externally via a content provider providing a server 1924 interconnected with the video telephone 402.

Referring now to FIG. 21, there is a flow diagram illustrating the manner in which a call connection may be created between a first video phone and an external video phone or non-video phone. Initially, the user presses a call button on the handset of the video telephone at step 2102. After pressing the call button, the user presses in the numbers associated with the called party at step 2104. The gateway processor 408 sends the dialed numbers at step 2106 to both the audio processor 422 and the video processor 420. Responsive to the received numbers, the video processor 420 provides at step 2108 a call setup view in the display and suspends operation of the browser 1926. The call setup view provides a visual indication to the user such as a “called number” display or “call ringing” indication when the call is ringing on the called line. Responsive to the receipt of the dialed numbers from the gateway processor 408, the audio processor 422 provides at step 2110 a dial tone indicating that an outgoing call line has been accessed. The dial tone is provided by the SIP functionalities 1902 within the audio processor 422.

The audio processor 422 sends at step 2112 a SIP message to the gateway processor 408. The SIP message includes the audio and visual codec capabilities of the calling video telephone 402. The gateway processor 408 converts the IP addresses associated with the SIP protocol and the IP addresses associated with the Ethernet protocol to the appropriate addresses using the SIP proxy 1912 and router/firewall/NAT module 1914 and forwards this information to the SIP server 1920. The SIP server 1920 generates a SIP invite at 2115 which is forwarded to the called party. The called party responds to the received SIP invite at step 2116, and the gateway processor 408 receives at step 2118 the called party's response. The appropriate address conversions are made by the router/firewall/NAT module 1914 and SIP proxy 1912 at the gateway 408 such that the audio processor 422 may be notified at step 1920 of the completion or non-completion of the call. Once the call is connected, the video processor 420 is notified at step 2122 by the audio processor 422 of the call connection. Inquiry step 1924 determines if the called party enables provision of an audio only or an audio/video call. If only audio is provided, an audio call is provided at step 2126. If an audio/video call is indicative, the video call is provided at step 2128. The call continues until the call is ended at step 2130.

If the called party is another video telephone according to the type described hereinabove, the receipt of a SIP server invite would cause the operation as illustrated in the flow chart of FIG. 22. Initially, the SIP invite is received by the gateway processor 408 at step 2202. The gateway processor 408 forwards the SIP invite at step 2204 to the audio processor 422. The audio processor 422 is able to read all of the codecs indicated within the received invite provided by the calling party and select the appropriate codecs at step 2206 for use with the call. Thus, if the video telephone 402 provides both audio and video capabilities, the video phone would select both an audio codec and a video codec for processing the call. Next, the audio processor 422 responds to the SIP invite at step 2108 indicating the codecs that will be used for completion of the call connection. This operation within the audio processor 422 is carried out by the SIP functionality 1902. Finally, the audio processor 422 and video processor 420 are able to connect with the calling party at step 2210 utilizing the selected codecs to provide a video telephone call between the calling party and the called party.

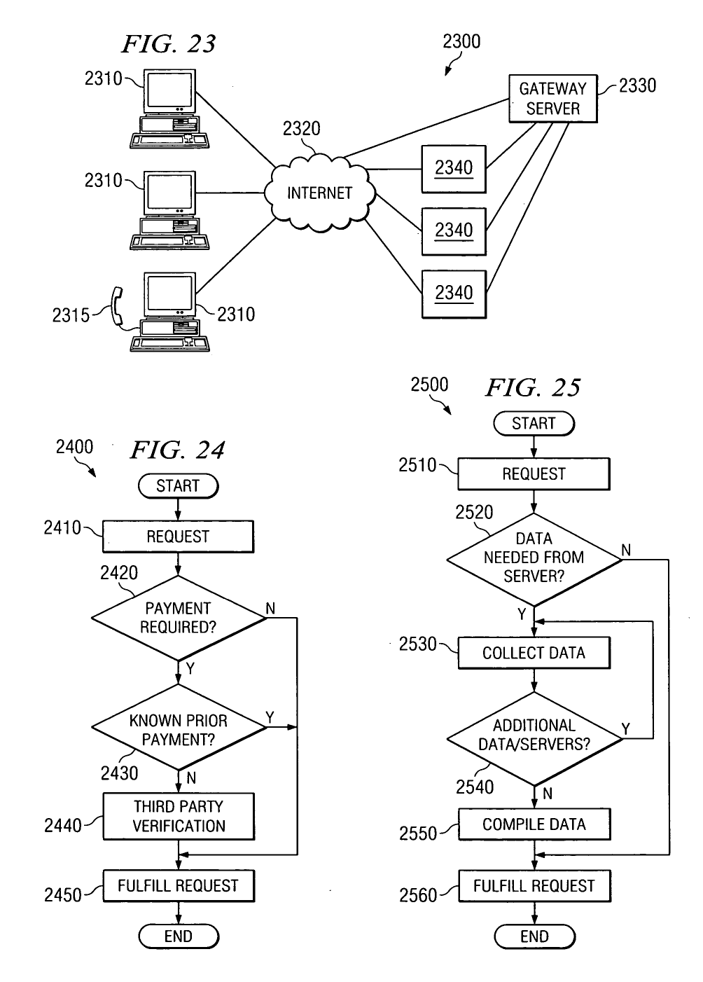

Referring now to FIG. 23, one embodiment of an operating environment 2300 for the IP video telephone described herein is shown. One or more IP video telephones 2310 are shown and one or more of these may have a standard handset 2315 attached. In another embodiment, one or more of the IP video telephones 2310 may be accessible by a user's analog home telephone network as previously described in reference to FIG. 9b. The basic functions of the IP video telephones 2310 may be substantially as previously described. Similarly, when equipped with a standard handset 2315 or interfaced with an analog telephone network, at least partial functionality of the IP video telephones 2315 may be available using only the handset 2315, another handset, or an analog phone connected to the analog network.

The IP video telephones 2310 may connect via a network 2320 to a host server 2330 interconnecting the network 2320 to a PSTN network, as previously described. The host server 2330 may be interfaced or connected with one or more media servers 2340. The host server 2330 may connect to the media servers 2340 by the network 2320 or by a direct connection. The network 2320 may be a local network, an area network, or the Internet. As will be described below, the media servers 2340 may act as content providers to the IP video telephones 2310 communicating through the host server 2330. In other embodiments, the IP video telephones 2310 may be configured to interface directly with the media servers 2340 through the network 2320.

The host server 2330 provides functionality that allows the IP video telephones 2310 to interact with an IP network (as described with respect to FIG. 4) 2320 and therefore other IP video telephones and devices capable of exchanging information using an IP network. The media servers 2340 likewise may be interfaced to the network 2320. The media servers 2340 may be analogous to web servers in the context of the world wide web. The media servers 2340 may be adapted to provide specific media content to one or more IP video telephones 2310 as will be described in greater detail below. The media servers 2340 may be owned or operated on behalf of a single entity or service provider or may be adapted to provide services on behalf of multiple clients or service providers similar to the manner in which a single entity may provide web hosting services to a wide array of clients.

In operation, an operator or user of one of the IP video telephones 2310 may desire to obtain information or data from a service provided by one of the media servers 2330. As previously discussed, the user may be able to enter data into the IP video telephone 2310 using an attached keyboard or one or more manual inputs associated with the IP video telephone 2340. A browser may be provided on the IP video telephone 2340, as previously described, in order provide one means of interacting with the IP video telephone 2340 and other devices on the network 2320. In another embodiment, a user may interact with the IP video telephones 2310 using only a traditional analog telephone handset 2315 and/or dial pad. In further embodiments, the user may request data or services from one or more of the media servers 2330 by preprogrammed voice commands or through voice recognition software residing on the IP video telephones 2310, the host server 2330, or the media servers 2340.

The media servers 2340 may be capable of providing various types of data and information to the IP video telephones 2310. The data or information provided may be static or interactive with the operator or user of the IP video telephone. The kind of data that may be provided upon request includes, but is not limited to, weather, travel, educational, news, and entertainment information. The media servers 2340 may also provide additional services including, but not limited to, food delivery requests and ordering, maintenance requests, online banking, account reporting, bookings, listings, email, online merchandise ordering, e-commerce solutions, and print distribution. The content provider operating through the media servers 2340 may be a public service organization providing information and services at no charge. In some cases, however, the information or service may require payment or a subscription.

The IP video telephones 2310 may provide, or be a part of, several methods to verify payment or subscription status. In the case of one of the IP video telephones 2310 having a permanent IP address, the media server 2340 may use the static IP address to verify an identification of the user or operator and an associated subscription or payment method. In another embodiment, the media server 2340 may seek a verification from the host server 2330. The host server 2330 may, for instance, allow the user to access services requiring payment by adding the cost of the service to a monthly access fee for the IP video telephone 2310. The host server 2330 or the media server 2340 may also seek verification of payment from a third party such as a bank or credit card processing service.

Referring now also to FIG. 24, a flow diagram 2400 corresponding to a method of verifying payment for media services in the environment 2300 via a third party is illustrated. A request for media services may be made by an IP video telephone 2310 at step 2410, as described. At step 2420 a determination may be made by the media server 2340 as to whether payment is required to fulfill the request. If yes, the media server 2340 determines at step 2430 if there is already a payment on record for the IP video telephone 2310, or its user making the request. If no payment has previously been recorded, the media server 2340 may request payment through a payment collection service or from another third party at step 2440. This may include forwarding the IP video telephone to a third party payment provider such as a bank or credit card processing service. In another embodiment, step 2440 may include contacting the host server 2330 to verify prior payment. After receiving payment or verifying prior payment, the original request may be fulfilled at step 2450. If either no payment is needed at step 2420, or payment has already been provided at step 2430, the request may be fulfilled at step 2450 without a verification or payment step.

Referring again to FIG. 23, in the scenarios described above, the IP video telephones 2310 may communicate with the host server 2330 and/or the media servers 2340 by initiating a VOIP call, possibly using SIP protocol as described in reference to FIG. 19. The appropriate information or service may also be accessed by dialing a traditional phone number and possibly using the handset 2315. In other embodiments, the information or service may be requested by accessing a particular Internet address such as a web site address, IP address, or some other valid address. The information or services may then be provided to the user by voice (e.g., a simple time and temperature) or by displaying information to a display screen associated with the IP video telephone 2310 (see, FIGS. 1, and 4-17). In cases where the information or service provided is interactive, voice commands may be provided by the user, or the user may interact with the service provided by the media server 2340 by using the dial pad, manual inputs, or other implements available on the IP video telephone 2310, as described with reference to FIG. 1.

In some instances, the user or operator of an IP video telephone 2310 may use a code or keyword to access data or services on the media servers 2340 through the gateway 2330. For example, if accessing a weather forecast service, the IP video telephone 2310 may be customized by particular user to access a pre-specified weather service when the user enters “weather” or “forecast” with an attached keyboard or other manual input. The keyword or code may also be entered numerically at the option of the user. For example, a user may assign the code “1” to the most frequently accessed data or services. In another embodiment, access could be keyed to a pre-programmed voice command.

Referring now also to FIG. 25, a flow diagram 2500 illustrates partial functionality of the environment 2300. Information or services are requested at step 2510 from one of the IP video telephones 2310. At step 2520 a determination is made as to whether fulfilling the request may require accessing data or subservices that may reside on one or more than of the media servers 2340. If yes, the host server 2330 may contact one of the media servers 2340 at step 2530 to collect the needed data or services. In other embodiments, one or more of the media servers 2340 themselves may contact other media servers to gain access to the information and subservices necessary to fulfill the user request. In some instances, more than one media server may need to be contacted. This determination may be made at step 2540 by the host server 2330. If additional media servers 2340 need to be contacted, the next media server 2340 is contacted at step 2530. At step 2540 if no more media data or services are needed to fulfill the user's request, the collected data and services may be compiled at step 2550 and the request fulfilled at step 2560. In the event that the host server 2330 determines at step 2520 that contact with one of the media servers 2340 is not needed, the user's request may be immediately fulfilled at step 2560.

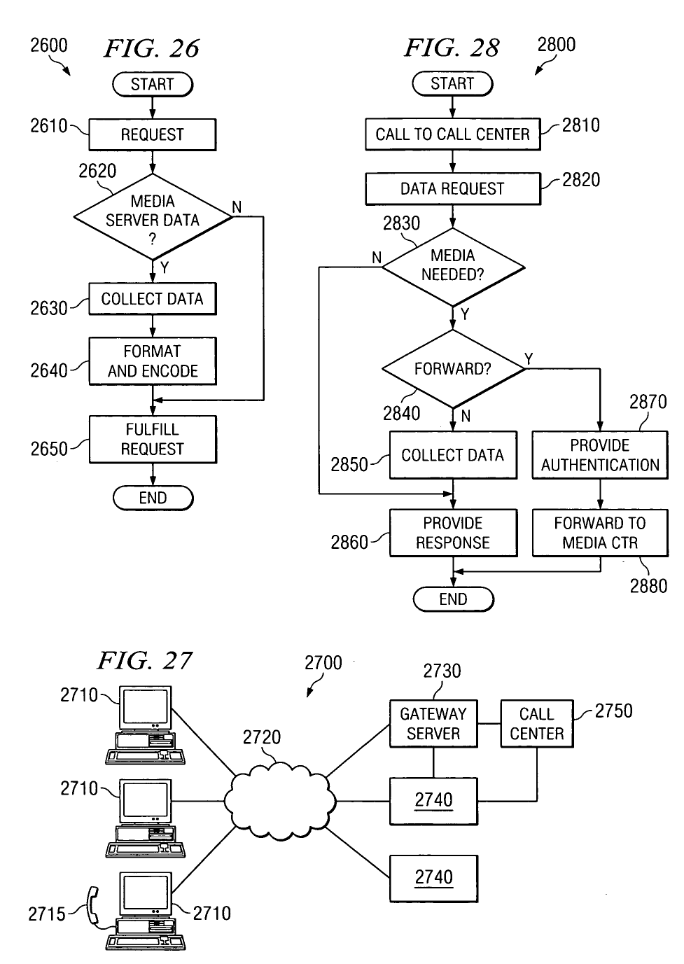

Referring now also to FIG. 26, a flow diagram 2600 illustrates an additional functionality of the environment 2300. In some embodiments, the host server 2330 may act as a media bridge to the IP video telephones 2310. A request is made from an IP video telephone 2310 at step 2610. The host server 2330 determines at step 2620 if data will be needed from one or more of the media servers 2340 to fulfill the user's request. If yes, the needed data and is collected by the host server 2330 from the media servers 2340, at step 2630, as previously described. The data collected may be unencoded or raw data such as a video or audio recording. The data collected may also be encoded in a format that is not compatible or desirable for the IP video telephones 2310. The host server 2330 may then encode or convert the data into a format suitable for display or interaction on the IP video telephones 2310, at step 2640. In some embodiments, the host server 2330 may also provide additional functionality including, but not limited to, combining, scheduling, directing, and/or managing the delivery of content from various content providers or media servers 2340. The host server 2330 may then fulfill the request to the IP video telephones 2310 using the newly encoded data. In the event that the host server determines at step 2620 that no media data is needed to fulfill the user's request, the request may be immediately fulfilled at step 2650

Referring now to FIG. 27 another embodiment of an operating environment 2700 for the IP video telephone described herein is illustrated. A plurality of IP video telephones 2710 are shown connecting through a network 2720 such as the Internet, to the host server 2730. The host server 2730 may also be in communication with one or more media servers 2740. In these respects, the environment 2700 of FIG. 27 is substantially similar to the environment 2300 of FIG. 23. However, the environment 2700 also features a call center 2750. The call center 2750 may be in communication with the host server 2730 and accessible to the IP video telephones 2710. In another embodiment, the IP video telephones 2710 may be able to communicate directly with the call center 2750.

The call center 2750 may server as a clearing house, or customer service center, capable of servicing multiple simultaneous requests for services and information from the users or operators of the IP video telephones 2710. In one embodiment, the call center 2750 houses a number of live operators who may be able to communicate by voice and/or video with users of the IP video telephones 2710. In another embodiment, the call center 2750 may be automated with a voice response system or may provide a combination of live operators and automated response systems.

Referring also now to FIG. 28, a flow diagram illustrating partial functionality of the environment 2700 is shown. In operation, a user of one of the IP video telephones 2710 may place a call, possibly using a phone number or an IP addresses, as previously discussed, and reach the call center 2750 at step 2820. In another mode of operation, a user may reach the call center by being forwarded to the call center by interactions with the host server 2730. The user may reach a live operator in the call center 2750 who will interact with the user via the user's IP video telephone. By interacting with a live operator in the call center 2750, or by interacting with the automated response system, the customer or user may request data or services from the call center 2750 at step 2820. For example, a customer or user of one of the IP video telephones 2710 may contact the call center in regards to warranty requests or technical support issues. In response to the user requests, the call center 2750 may wish to provide data or services available at one or more of the media servers 2740. If access to one of the media servers 2740 is needed at step 2830, the call center may determine to provide the data directly at step 2840 rather than forwarding the user to the media server 2740. The call center 2750 access the media server 2740 and collects the needed data or services at step 2850 and provides the response at step 2860 to the IP video telephone 2710 via the host server 2730 and network 2720. The call center may request that the IP video telephone user contact the appropriate media server separately at step 2840 using one the techniques previously described. In such case, the call center 2750 may provide a passcode, a network address (such as an IP address), or a call number to the media server 2740 at step 2880. In some cases the passcode may only be valid for a limited time. The call center may “forward” the user of the IP video telephone 2710 to the media center 2740 at step 2870 and the IP video telephone 2710 may interact with the media server 2740 either through the gateway sever 2730, or directly with the media server 2740 through the network 2720.

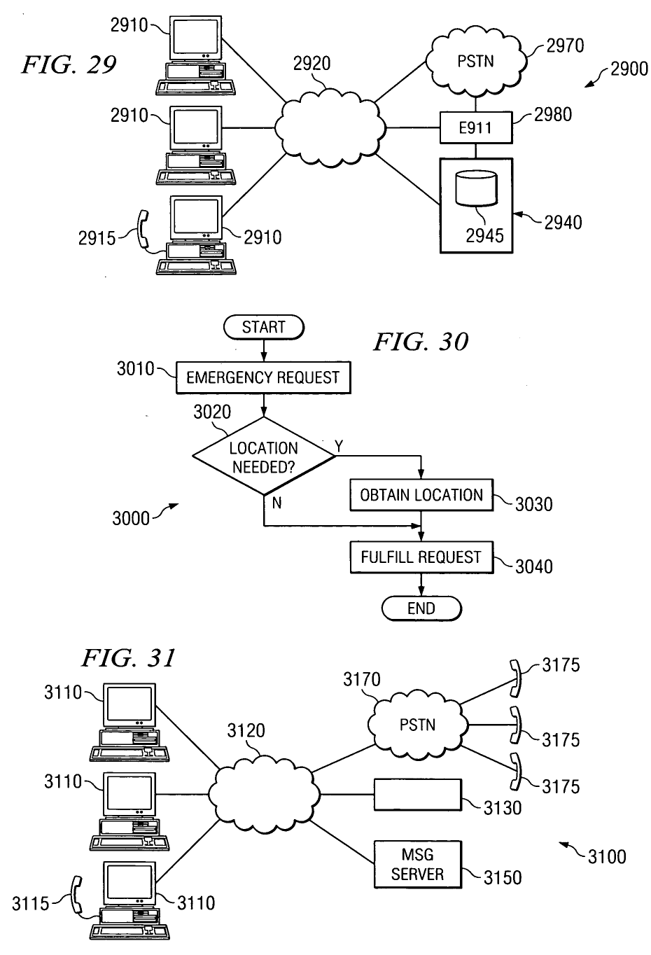

Referring now to FIG. 29, another embodiment of an operating environment 2900 for the IP video telephone disclosed herein is shown. The environment 2900 is substantially similar to environments 2300 and 2700 previously disclosed. A plurality of IP video telephones 2910 are shown connecting to a network 2920, which may be a broadband network such as the Internet. As in previous environments, the IP video telephones may be able to make and receive calls through a host server 2940 also connected to the network 2930. In the embodiment shown, a Public Switched Telephone Network (PSTN) 2970 is also interfaced to the network 2930 and to the IP video telephones 2910 in order to place and receive calls to and from entities with non-VOIP telephones on the PSTN 2970. An emergency/911 (E911) service 2980 is shown interfaced to the PSTN 2970. In some embodiments, the E911 service 2980 may interface with the network 2920 using VOIP technology. This may be in addition to, or instead of, a connection to the PSTN 2970.

The E911 service 2980 may have the need to automatically locate a caller to the service. In the case of a VOIP device such as the IP video telephones 2910, there may be no readily available way to locate a caller as with using a traditional phone number associated with a traditional analog telephone set connected to the PSTN 2970. In such case, when a call is made from one of the IP video telephones 2910 to the E911 service 2980, the host server 2940 may provide a physical address associated with the particular one of the IP video telephones 2910 from which the call has been made. The host server 2940 may maintain a database 2945 for accessing physical locations and addresses. For example, the host server 2940 may maintain an internal relational database 2945 which may link a physical address of a caller to a unique ID number associated with a particular one of the IP video telephones 2920. The E911 service 2980 may also maintain a database in addition to, or instead of, relying on the host server 2940 to provide the information. For example, the E911 service may have a database associating a static network address (e.g., a static IP address) with the physical location of any of the IP video telephones 2910 and therefore the caller using the device. In another embodiment, the E911 service 2980 may be configured to accept the physical address of a calling IP video telephone 2910 directly through the network 2920 with a data transfer from the IP video telephone 2910 itself.

Referring now also to FIG. 30, a flow diagram 3000 illustrating partial functionality of the environment 2900 is shown. In operation, a caller using one of the IP video telephones 2910 may have need of emergency services such as, police, ambulance, or fire department assistance. A user of an IP video telephone 2910 may place a call to the E911 service 2980 at step 3010 by entering a keyword on the appliance, entering a known network address, or using a manual input. The user may be placed in voice and/or video communication with an operator of the E911 service 2980. If an operator of the E911 service 2980 requires the physical address of the user at step 3020 it may be provided upon request at step 3030. In some embodiments, the physical address may be provided automatically by some triggering event such as the user placing the call but being unable to verbally communicate. As described above, the physical location information may be provided at step 3030 by the E911 service's 2980 own internal database, by the host server 2940, or by the IP video telephone 2910 itself. The E911 service 2980 then has the physical location of the caller should the E911 service 2980 have need to dispatch the police, an ambulance, the fire department, or another service at step 3040. In an another embodiment, other entities such as a utility company may be connected to the PSTN 2970 and/or network 2920, possibly using an IP video telephone 2910, and therefore also be able to take advantage of the automatic location services provided by the environment 2900. In the event that the service provided by the E911 service does not require a physical location of the caller at step 3020, the request may be fulfilled without location information at step 3040.

Referring now to FIG. 31, another embodiment of an operating environment 3100 for the IP video telephone disclosed herein is shown. A plurality of IP video telephones 2410 are connected through a network 3120, which may be the Internet, to a host server 3150. In this respect, the environment 3100 is similar to the environments 2300, 2700, and 2900 previously discussed. However the present environment also features a message server 3150, which may be accessible through the network 3120 by the host server 3130 and/or the IP video telephones 3110. In another embodiment, the message server 3150 may be integrated with, or directly connected to, the host server 3130. The environment 3100 also features access to a Public Switched Telephone Network (PSTN) 3170. The PSTN 3170 may accessible via the network 3120 through the host server 3150. Typically, a number of PSTN subscribers with traditional analog telephone sets 3175 may have access to, or be connected to, the PSTN 3170.

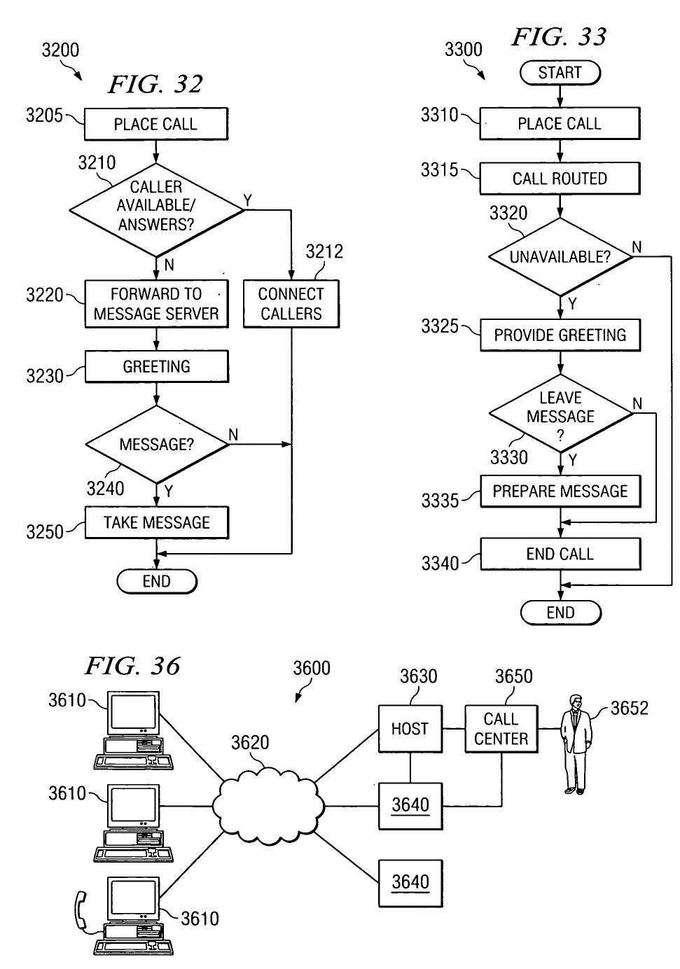

Referring now to FIG. 32, a flow diagram 3200 illustrating one embodiment of a method of providing messaging services to IP video telephones is shown. As described briefly with respect to FIGS. 16-17, the IP video telephones 3110 may be equipped with hardware and/or software enabling them to provide interactive messaging services. In operation, a first user, or caller, of one of the IP video telephones 3110 may attempt to reach a second user, or call recipient, through the network 3120 and host server 3130 at step 3205, as previously described. If the recipient is available at step 3210, the caller and recipient may be connected at step 3212. If the recipient is unavailable at step 3210 because, for example, the recipient user may be away from the device and unable to answer, or may already be disposed with another transaction, the host server 3130 may forward the caller to the message server 3150 at step 3220. The message server 3150 may provide interactive messaging services to the caller. The message server 3150 may provide a preprogrammed or customized greeting at step 3230 according to the preference of the recipient. The caller may choose to leave a message at step 3240. The message server 3150 may receive the message at step 3250, which may include voice and image data and possibly other media which may be included directly in the message, or included by reference to another media server such as those disclosed with reference to environment 2300.

In another embodiment, the IP video telephones 3110 may have the capability of storing messages internally in a manner similar to a traditional answering machine, but having extended capabilities. In such case, the caller may not be forwarded to the message server 3150, but may be able to leave a message and interact directly with the recipient's own IP video telephone 3110.

It is also possible for those not having an IP video telephone 3110 to take advantages of at least some of the capabilities of the IP video telephones 3110 in the environment 3100. For example, a caller using a traditional handset 3175 on the PSTN 3170 may place a call using the PSTN 3170 which may route the call to the host server 3130. The host server 3130 can then route the call to the appropriate IP video telephone 3110 through the network 3120. If the caller finds the recipient unable to answer, the call may be forwarded back to the message server 3150. The caller may then have the option of leaving a message for the recipient. The message may be limited in its content due to the limited interaction capabilities of the analog telephones 3175. In another embodiment, the IP video telephones 3110 may be able to directly receive and store the message from a caller using the PSTN 3170 and analog phone 3175.

Referring now to FIG. 33, the flow diagram 3300 illustrates some additional aspects of the process described above. At step 3310 a caller places a call using an IP video telephone. At step 3315 the host server routes the call to the recipient who is found to be unavailable at step 3320. At step 3325 the message server provides the caller with the appropriate greeting and messaging options. The caller's interaction with the messaging server may include both audio and video interaction. For example, the caller may have both audio and visual queues presented on the caller's own IP video telephone. The caller may have the option of preparing or leaving a message at step 3330. If the caller chooses to provide a message at step 3330, the caller is provided with the appropriate audiovisual queues and interaction by the message server at step 3335 to prepare the message. If the caller chooses not to provide a message at step 3330, the caller can choose to end the call at step 3340.

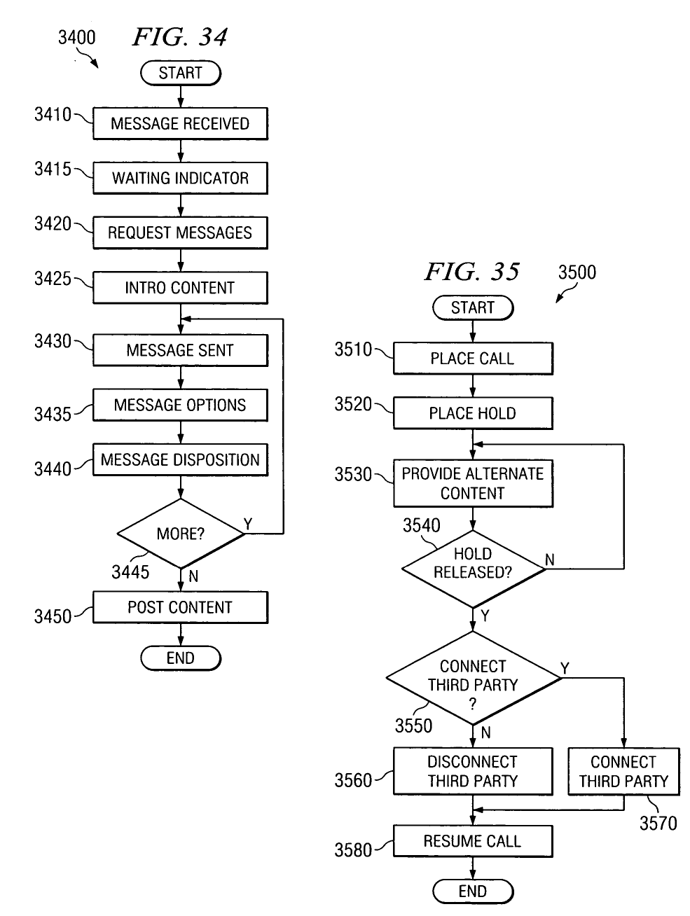

Referring now to FIG. 34, a flow diagram 3400 illustrating a portion of the process flow of a recipient accessing messages is shown. At step 3410 a message may be left for the recipient as previously described. At step 3415 the recipient's IP video telephone may provide an indicator that a message is available. For example, the video display associated with the IP video telephone may provide a queue to the recipient that the message is ready. In other embodiments, the notification may take the form of an audible queue or an LED provided on the IP video telephone. At step 3420 the recipient requests to view or access the messages. As described, the messages may be stored locally on the IP video telephone, or may be stored on a message server accessible over a network by the IP video telephone. At step 3425 introductory content may be provided by the message server. For example, the message server may provide information as to the number of callers and messages since the last time messages were checked. Other introductory content may include, but is not limited to, advertising information, billing information, usage statistics, and an option to request a help screen or tutorial in accessing the messaging system. At step 3420 a first message is delivered to the recipient. Following viewing the message, the recipient is presented response options at step 3435. Options for responding to a message can include, but are not limited to, saving the message for later access, deleting the message, forwarding the message, which may including appending or annotating the message, or skipping the message. The recipient may also have the option of having the IP video telephone initiate a call back to the sender of the message. The recipient enters the chosen action at step 3440 using an input on the recipient's IP video telephone as previously described. If additional messages are available at step 3445, the next message may be delivered at step 3430. If no additional messages are available at step 3445, post-message content may be provided by the message server at step 3450. Post-message content may include but is not limited to, advertising information, billing information, and usage statistics.

Referring now to FIG. 35 a flow diagram 3500 corresponding to a hold functionality provided with the IP video telephones described herein is shown. A recipient or caller on an IP video telephone as herein disclosed may have the option of placing a party on hold. A call may be placed at step 3510 and either the recipient or caller may place the other on hold at step 3520 using a manual input on the IP video telephone for example. When the hold is placed, the host server may provide alternate content to the caller and/or the recipient at step 3530. In one embodiment, the video content may be a blank screen or other video or information that can optionally be chosen by either the caller or recipient. Similarly, alternate audio content may be provided, or the audio portion of the call may be silenced. In one embodiment, when a caller or recipient is placed on hold, he or she may be able to access other features of the IP video telephone. For example, the caller placed on hold may be able to access email or calendar functions, or may be able to place another call and be alerted when the previous caller returns. The hold may continue until it is released by the party initializing it at step 3540. The party placing the hold may also be able to make alternate communications during the hold time. For example the caller or recipient may confer privately with a third party before return to the held call. The decision may be made at step 3560 to disconnect the third party at the end of the hold at step 3560. Alternately, the decision may be made at step 3550 to include the third party on the call at step 3570. The original call then resumes at step 3580.

In the embodiments described above in reference to FIGS. 23-35, the environments and networks may initially have few participants. Potential service providers and potential IP video telephone users both may wish to employ various techniques to increase participation on the networks. For example, service providers may identify potential customers or users of IP video telephones. IP video telephones may be provided to a number of customers at a reduced rate. In some instances, the devices may be provided below cost, or even given away free. A service provider may be able to provide the devices for free or at a reduced rate in exchange for the end user agreeing to a minimum length of service contract. In some instances, the IP video telephone may be provided as a service of the user's broadband Internet access provider. In other instances, the device may be part of a lease commensurate with a service agreement wherein the IP video telephone is provided for a monthly fee that may be included with the bill for the network access.

In addition to home users of IP video telephone users communicating between themselves using the devices and techniques herein described, home users of IP video telephones may wish to utilize IP video telephones to take advantage the additional features described herein that are not normally available via traditional analog telephone set. In such case, a distributor of general network services, Internet access, or IP video telephones, may initially provide certain businesses or service providers with IP video telephones at a reduced rate. When the number of network participants has grown to a sufficient size to attract customers and additional businesses without such subsidies, prices may return to the normal market rate. In a similar manner, merchants and advertisers may be charged per revenue or per customer contact generated as a result of using the IP video telephone.

Referring now to FIG. 36 another embodiment of an operating environment 3600 for the IP video telephone described herein is illustrated. A plurality of IP video telephones 3610 are shown connecting through a network 3620, such as the Internet, to ta host server 3630. The host server 3630 may also be in communication with one or more media servers 3640. In these respects, the environment 3600 of FIG. 36 is substantially similar to the environment 2300 of FIG. 23. However, the environment 3600 also features a call center 3650. The call center 3650 may be in communication with the host server 3630 and accessible to the IP video telephones 3610. In another embodiment, the IP video telephones 3610 may be able to communicate directly with the call center 3650.

The call center 3650 may serve as a clearing house, or customer service center, capable of servicing multiple simultaneous requests for services and information from the users or operators of the IP video telephones 3610. In the present embodiment, the call center 3650 may serve as a content provider capable of providing data and services directly to one of more of the IP video telephones 3610. In one embodiment, the call center 3650 houses one or more live operators 3652 who may be able to communicate by voice and/or video with users of the IP video telephones 3610. In another embodiment, the call center 3650 may be automated with a voice response system or may provide a combination of live operators and automated response systems.

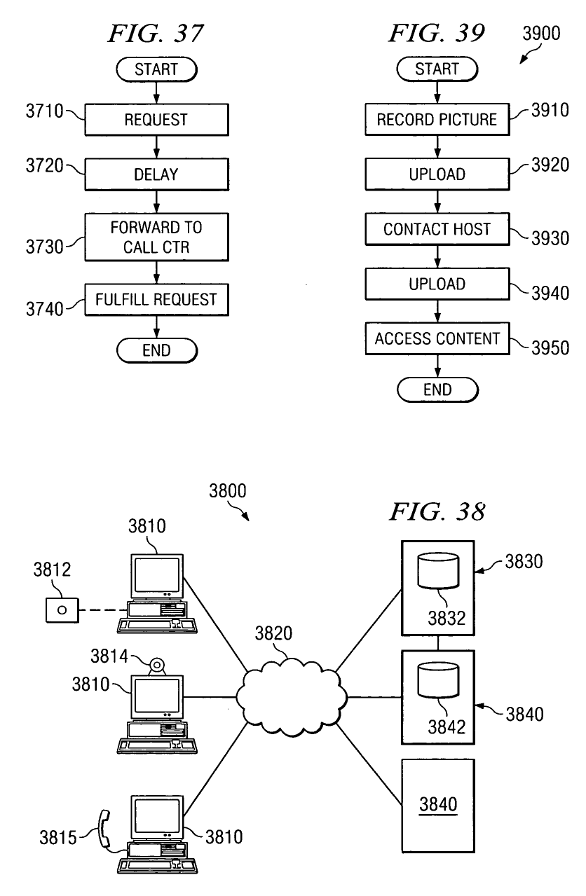

Referring also now to FIG. 37, a flow diagram 3700 that illustrating a portion of the process flow of the operation of the environment 3600 is shown. At step 3710 a user of an IP video telephone 3610 sends a request to the host server 3630. The request may be for immediate data, services, or information, or, as in the present case, the request may be for fulfillment at a future time. The host server 3630 may delay the request at step 3720 until the time requested by the user of the IP video telephone 3610. At step 3730 the host server 3630 forwards the request to the call center 3650. The call center 3650, acting through a live operator 3652, or through an automated response system, fulfills the request at step 3740. Fulfilling the request may also require that the call center 3650 request data or services from one or more of the media servers 3640, as previously described. In another embodiment, the host server 3630 may pass the request directly to the call center 3650 without delay, essentially bypassing step 3720. In such case, a delay may occur on the part of the call center 3650 before the request is fulfilled. When fulfilling the request at step 3740 the operator 3652 at the call center 3650 engages the IP video telephone user in two-way audio-visual communication. During the course of such a call, the operator 3652 may transmit audio visual media content as appropriate. This content may include content retrieved from one or more of the media servers 3640. The operator 3652 may also send e-mail, print material or other forms of communication to the consumer pursuant to fulfilling the request.

Referring now to FIG. 38, another operating environment 3800 for the IP video telephone disclosed herein is shown. A plurality of IP video telephones 3810 are shown connecting through a network 3820, such as the Internet, to a host server 3830. The host server 3830 may also be in communication with one or more media servers 3840. In these respects, the environment 3800 of FIG. 38 is substantially similar to the environment 2300 of FIG. 23. However, the environment 3600 also features one or more digital cameras 3812, 3814, which may be attached or interfaced with one or more of the plurality of IP video telephones 3810. The digital camera 3812 may be a still digital camera or a digital camcorder capable of recording motion video and/or audio. The digital camera 3812 may be a mobile device designed to interface with the IP video telephones 3810 only when transferring or uploading pictures as described below. The camera 3814 may be a mounted CCD camera designed to remain attached to the IP video telephone 3810. In one embodiment, rather than being a separately attached component, the mounted camera 3814 may be integrated with the IP video telephone 3810 as previously described.

Referring also now also to FIG. 39, a flow diagram 3900 illustrating partial functionality of the environment 3800 is shown. At step 3910, digital pictures or audiovisual content is recorded with one of the cameras 3812, 3814. At step 3920 the recorded content may be uploaded into one of the IP video telephones 3810, possibly into an internal memory associated with the IP video telephone 3810. The IP video telephone 3810 may contact the host server 3830 through the network 3820 at step 3930. The content may then be uploaded to the media server 3840 at step 3940. In another embodiment, the content may be uploaded to the media server 3840 without being stored locally on the IP video telephone 3810. In still another embodiment, the content may be uploaded and stored on the host server 3830 rather than a media server 3840. Both the host server 3830 and one or more of the media servers 3840 may be equipped with databases 3832 and 3842, respectively, that store the recorded content. The recorded content may then be available and accessible by one or more of the IP video telephones 3810 at a future time at step 3950. In one embodiment, still photographs may be stored on the media server 3840 and sent over the network 3820 for display on a display associated with one of the IP video telephones 3810. The photograph displayed may be manually selected or may be set to change at a specified interval such as to create a slide show effect. In another embodiment, a photograph associated with a particular caller may be displayed on the IP video telephone when a communication is received from that caller.

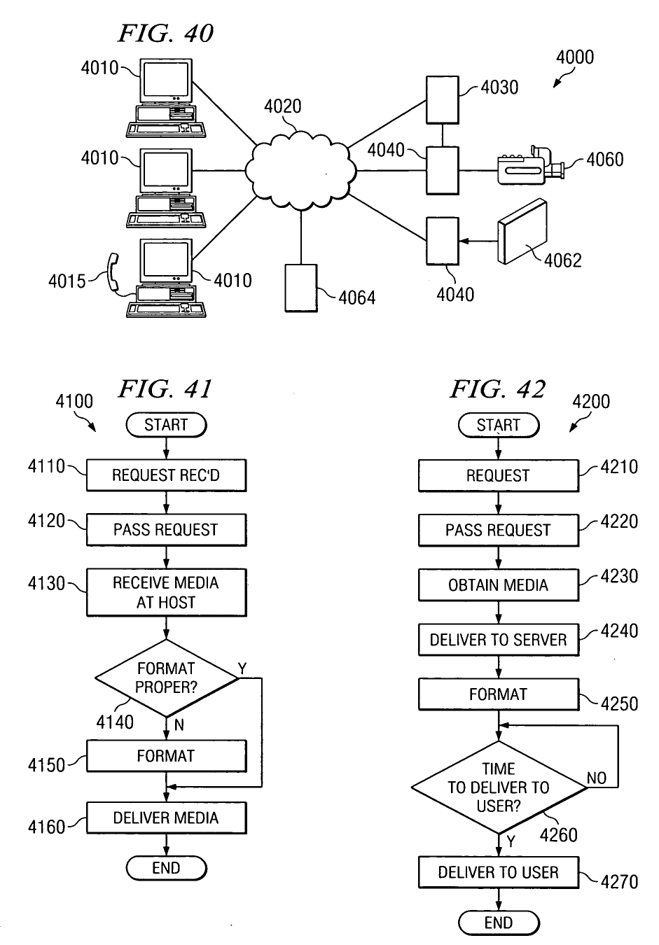

Referring now to FIG. 40, another operating environment 4000 for the IP video telephone described herein is shown. A plurality of IP video telephones 4010 are shown connecting through a network 4020, such as the Internet, to a host server 4030. The host server 4030 may also be in communication with one or more media servers 4040. In these respects, the environment 4000 of FIG. 40 is substantially similar to the environment 2300 of FIG. 23. However, the environment 4000 also features a number of media sources such as a video media source 4060, a print media source 4062, and a web-based media source 4064.

The video media source 4060 may be a raw or encoded video, audio, or audiovisual signal, such as a satellite or cable television feed or a broadcast radio feed. In other embodiments, the video media source may be an existing analog or digital media player such as a video cassette record (VCR), a digital video disc (DVD) player, or a compact disc (CD) player. The video media source 4060 may be interfaced to provide content to one or more of the media servers 4040. In another embodiment, the video media source 4060 may provide content directly to the host server 4030. The print media source 4062 may be a database of printed material, a repository of digital or electronic books, or some other source of printed material that is accessible digitally or can otherwise be made available either to the media severs 3040 or the host server 3030. The web-based media source 4064 may be a traditional web server that may be accessible through the network 4020. The web-based media source 4064 may provide Internet media such as web pages and streaming audio and video.

Referring now also to FIG. 41, a flow diagram 4100 illustrating partial functionality of the environment 4000 is shown. At step 4110 a request is received by the host server 4030 from one of the IP video telephones 4010. The request may be received over the network 4020 and may include a request for specified content which may include a variety of media types. The requested media may be accessible through one or more of the media severs 4040. In such case, the request may be made to the appropriate media sever 4040 at step 4120. The media may be received by the host server 4030 at step 4130. At step 4140, the media received may not be in the correct or optimal format for transmission to, or viewing by, the IP video telephones 4010. At step 4150 the media may then be encoded, combined, compressed, converted, or otherwise altered or formatted prior to being sent to the IP video telephones 4010 at step 4160. The media may then be delivered to the IP video telephone 4010 making he request at step 4160. In some instances, if the media received is already properly formatted at step 4140, the may be directly transmitted to the IP video telephone at step 4160.

Referring now also to FIG. 42, a flow diagram 4200 illustrating additional functionality of the environment 4000 is shown. The flow diagram 4200 illustrates some of the scheduling capabilities associated with the environment 4000. At step 4210, a request is made by one of the IP video telephones 4010 to the host server 4030 requesting media services. The request may be a request for media data or services that the user wishes to have fulfilled at a later time. At step 4120, the host server 4030 passes the request to one or more of the media servers 4040. In this embodiment, because the request may be for delivery of content at a future time, the host server 4030 and/or the media servers 4040 may be able to schedule the request behind other requests or duties which may be more time critical. At step 4230, the media servers 4040 obtain the requested media information from one or more of the media sources 4060, 4062, 4064. In some cases, the media servers 4040 may have to wait to obtain the desired media content, for example, when the request is for a particular media program such as a television broadcast that may not be available until a future point in time. The media servers 4040 may then fulfill the request for the content at step 4240 by delivering the content to the host server 4030. As previously described with respect to FIG. 38, at step 4250, the host server 4030 may be required to alter, combine, encode, format, or otherwise prepare the data obtained from the media servers 4030 for use by the IP video telephones 4010. When the received content has been prepared, and the requested data and services are ready to be delivered, the host server may wait at step 4260 until a proper time to deliver the media content and fulfill the request at step 4270. As with previous illustrations, alternate embodiments are possible. For example, in this embodiment, the host server 4030 may pass the request to the media servers 4040 which may perform the appropriate formatting and may also pass the requested media data back to the IP video telephones 4010 at the appropriate time.

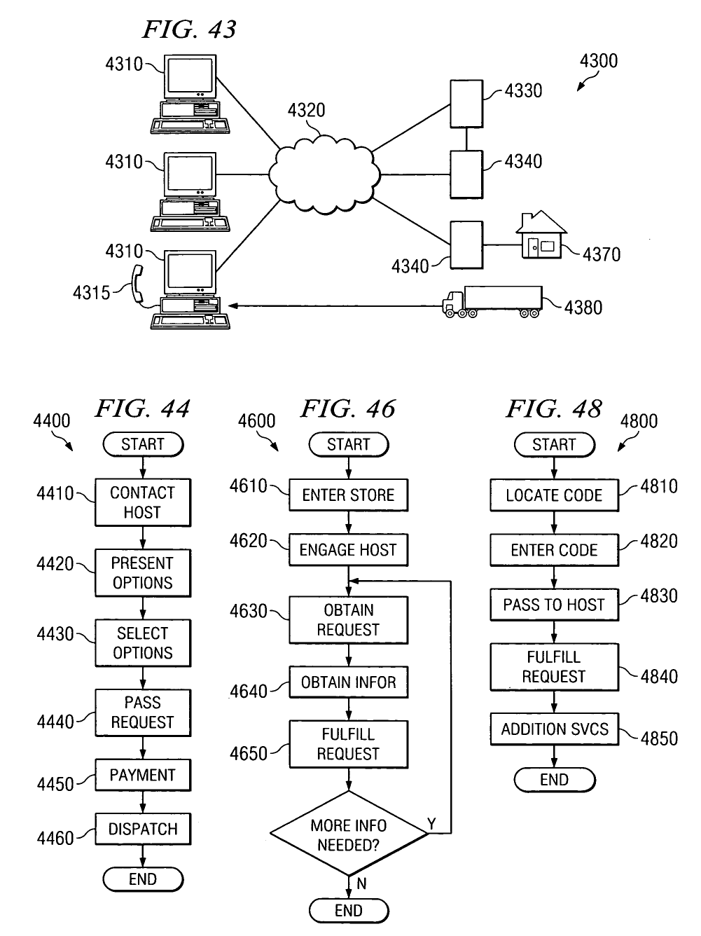

Referring now to FIG. 43 another operating environment 4300 for the IP video telephones described herein is shown. A plurality of IP video telephones 4310 are shown connecting through a network 4320, such as the Internet, to a host server 4330. The host server 4330 may also be in communication with one or more media servers 4340. In these respects, the environment 4300 of FIG. 43 is substantially similar to the environment 2300 of FIG. 23. However, the environment 4300 also features one or more service providers 4370. The service provider 4370 may be associated with one of the media servers 4340, as shown, or it may communicate with the host server 4030 through an IP video telephone 4310. The service provider 4370 may also have means for transportation 4380 and/or providing physical services to a location of a requesting IP video telephone 4310 as described below. The means for transporting 4380 or providing services may be a courier or delivery service. In some embodiments, the means for transporting 4380 may correspond to a dispatched service vehicle, such as a tow truck, repair van, taxi cab, or other service provider than may provide services at a specified location.

Referring now to FIG. 44, a flow diagram 4400 illustrating partial functionality of the environment 4300 is illustrated. At step 4410, a user of an IP video telephone 4310 places a call or initiates communication with the host server 4330. The user may be request services that may not be deliverable via the IP video telephones 4310. The user may be requesting delivery of a physical item, a service call to a physical address, a transportation service, or another service that may not be deliverable over the network 4320. In some embodiments, at step 4420, the host server 4330 may provide alternative service choices to fulfill the request. For example, if the user is requesting physical delivery of a item, the host server 4330 may query multiple delivery services and present to the user the lowest cost options. The user selects an option at step 4430, and the host server 4030 passes the request to the service provider 4370 at step 4440. In some embodiments, the service provider may communicate with the host server 4330 through a media server 4340. In other embodiments, the service provider 4340 may communicate with the host server 4330, and possibly the user, via an IP video telephone 4310. As in previous embodiments, the host server 4330 may facilitate payment arrangements for the service at step 4450. In other embodiments, the payment may be facilitated directly between the user and the service provider. At step 4490 the request is fulfilled possibly by the dispatch of the transportation means 4380 to a location of the user or IP video telephone 4310.

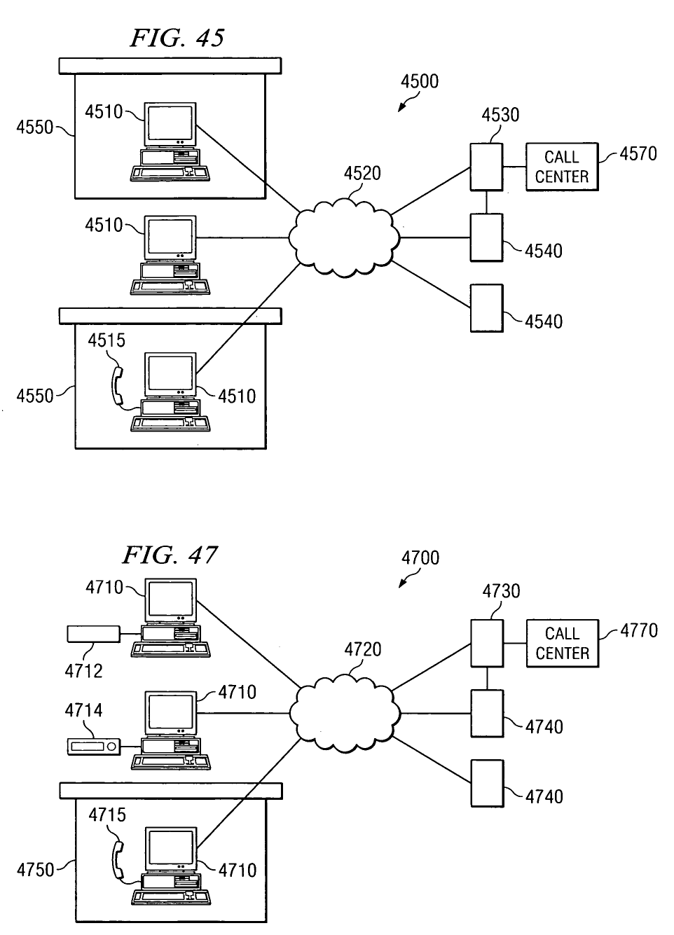

Referring now to FIG. 45, another operating environment 4500 for the IP video telephones disclosed herein is shown. A plurality of IP video telephones 4510 are shown connecting through a network 4520, such as the Internet, to a host server 4530. The host server 4530 may also be in communication with one or more media servers 4540. In these respects, the environment 4500 of FIG. 45 is substantially similar to the environment 2300 of FIG. 23. However, the environment 4500 also features one or more retail or service locations 4550 which may utilize one or more of the IP video telephones 4510, as will be described below. The retail locations 4550 may be retail department stores, specialty stores, catalog showrooms, or other locations that may benefit from interacting with customers via IP video telephones 4510. The retail locations 4550 may also correspond to service centers such as automotive service centers, hospitals, or other locations providing services that may benefit from interacting with customers via an IP video telephone 4510. One or more of the retail locations 4550 may also be associated with a call center 4570, which may server to additionally assist customers as described below.

Referring also now to FIG. 46, a flow diagram 4600 whish illustrates partial operation of the environment 4500 is shown. In one embodiment, the environment 4500 serves to operate as a private broadcast network to the IP video telephones 4510 in the retail locations 4550. A customer may enter one of the retail locations 4550 at step 4610. Pursuant to a service or product provided at the location 4550, the customer may wish to obtain details or additional information regarding an ongoing or contemplated transaction through the user of one of the on-site IP video telephones 4510. At step 4620, the customer engages the host server 4530 via one of the IP video telephones 4510. The host server 4530 may interact with the customer at step 4630 to obtain any additional information needed to fulfill the customers wishes or needs. In one embodiment, the customer may use the IP video telephone 4510 to request additional information regarding a product or service being considered for purchase. In another embodiment, a customer may use the IP video telephone 4510 to request customization options, or the status of an item being serviced, for example, a car at an auto repair facility. In yet another embodiment, the customer may use the IP video telephone 4510 at a catalog showroom to check the status of additional options and features that may be available but not shown or displayed at the showroom. At step 4640, the host server 4530 may interact with one or more media servers 4540 to obtain the information requested. At step 4650, the host server 4530 provides the requested information back to the user at the IP video telephone 4510. In some embodiments, the process of interacting to obtain additional information may repeat at the option of the customer at step 4660. Additionally, in some embodiments, the IP video telephones 4510 may be able to interact directly with the media servers 4540 without the intervention of the host server 4530. In further embodiments, the retail locations 4550 may be associated with a call center 4570, possibly having live operators, who may be able to provide personal assistance to callers instead of, or in addition to, the media servers 4540.

Referring now to FIG. 47, another environment 4700 for the operation of the IP video telephones described herein is shown. A plurality of IP video telephones 4710 are shown connecting through a network 4720, such as the Internet, to a host server 4730. The host server 4730 may also be in communication with one or more media servers 4740. The environment 4700 also features one or more retail or service locations 4750 which may utilize one or more of the IP video telephones 4710 as will be described below. The retail location 4750 may be retail a department store, specialty store, catalog showroom, or other location that may benefit from interacting with customers via IP video telephones 4710. The retail location 4750 may also correspond to a service center such as automotive service centers, hospital, or other location providing services conducive to interacting with customers via an IP video telephone 4710. A call center 4770, possibly having live operators, may also be provided and accessible to the IP video telephones 4710. In the respects noted above, the environment 4700 is substantially similar to the environment 4500 previously discussed. As described with respect to FIGS. 1-4, the IP video telephones 4710 may have multiple input devices associated therewith. For example, a scanning device 4712 may be associated with one or more of the IP video telephones 4710. The scanning device 4712 may be an optical scanner, a card reader, or another device capable of accepting a code to be used by the IP video telephones 4710. One or more of the IP video telephones may also feature a keyboard 4714, or a traditional analog handset 4715, as previously described.

Referring also now to FIG. 48, a flow diagram 4800 illustrating partial functionality of the environment 4700 is shown. A user of one of the IP video telephones 4710 may wish to obtain additional information regarding a product in a show room, which may be located at retail location 4750. A home user with a printed or online catalog may also desire additional information regarding a given product. At step 4810 such a user locates a product identifier for the product of interest. In the case of a printed catalog, the identifier may be a product or stock number. A bar code or other scannable marking may be provided in the catalog corresponding to the product. At step 4820 the identifier is entered into the IP video telephone 4710. In one embodiment, the product may be identified by scanning, as with scanner 4714. The scanner 4714 may also be capable of optical character recognition to avoid the need or printing bar codes or other machine codes in the catalog. The product may also be identified by the keyboard 4714. The IP video telephone 4710 may pass the information request to the host server 4730 at step 4830. The request may then be passed to an appropriate media server 4740 in order to obtain the requested information at step 4840. In another embodiment, the request may be passed to an operator at the call center 4570 instead of, or in addition to, the media server 4740. At step 4840, the request may be fulfilled. The request may be fulfilled by providing the requesting information back to the user. In addition, the user may be connected by the host server 4730 to the call center 4770, and possibly a live operator in order to provide additional information and assistance. In another embodiment, a user using only a handset 4715 and the IP video telephone 4710, may be able to request at least limited information by a connection through the host server 4730 directly to the call center 4570. Once information has been provided at step 4840, additional services may be provided at step 4750 such as providing ordering and service request capabilities as preciously described.

It will be appreciated by those skilled in the art having the benefit of this disclosure that this invention provides a broadband information appliance. It should be understood that The drawings and detailed description herein are to be regarded in an illustrative rather than a restrictive manner, and are not intended to limit The invention to The particular forms and examples disclosed. On The contrary, The invention includes any further modifications, changes, rearrangements, substitutions, alternatives, design choices, and embodiments apparent to those of ordinary skill in The art, without departing from The spirit and scope of this invention, as defined by The following claims. Thus, it is intended that The following claims be interpreted to embrace all such further modifications, changes, rearrangements, substitutions, alternatives, design choices, and embodiments.

1. A method of providing media content to a plurality of IP video telephones, the method comprising:
receiving a request for a specified media content from a first IP video telephone;
requesting a first media feed corresponding to the specified media content from a first media source;
receiving the first media feed from the first media source;
converting the first media feed to an IP video phone compatible format media file; and
transmitting the media file to the IP video telephone.

2. The method of claim 1 further comprising:
requesting a second media feed corresponding to the specified media content from a second media source;
receiving the second media feed from a second media source; and
wherein the step of converting further comprises converting the second media feed into the IP video phone compatible format media file.

3. The method of claim 1 the step of transmitting the media file to the IP video telephone further comprises transmitting the media file to the IP video telephone via the Internet.

4. The method of claim 1 wherein the step of receiving a request further comprises receiving a request as a predetermined code.

5. The method of claim 1 wherein the specified media content is an analog television signal.

6. The method of claim 1 wherein the step of transmitting further comprises transmitting the media file as streaming media.

7. The method of claim 1 wherein the media file comprises audio and video data.

8. The method of claim 1:
wherein the step of receiving a request for a specified media content includes receiving a request for specific delivery time; and
wherein the step of transmitting the media file further comprises transmitting the media file at the specific delivery time.

9. A method of providing multimedia access to product and services information to a customer, the method comprising:
accepting an product identifier from a customer at a customer location having an IP video telephone;
retrieving information associated with the product identifier; and
transmitting information associated with the product identifier to the IP video telephone.

10. The method of claim 9 wherein the customer location is a retail store.

11. The method of claim 9 wherein the product identifier is a product part number.

12. The method of claim 9 wherein the product identifier is a scannable code.

13. The method of claim 9 wherein the information associated with the identifier comprises audio-visual media.

14. The method of claim 9 further comprising accepting from the customer a request for a product associated with the product identifier.

15. The method of claim 9 further comprising arranging for delivery to the customer of a product associated with the product identifier.

16. The method of claim 9 further comprising placing the customer in audio-visual contact with an operator.

17. A method for providing access to media content to a plurality of IP video telephones, the method comprising:
receiving media content from a transmitting IP video telephone;
storing the media content; and
transmitting the media content to a receiving IP video telephone upon request.

18. The method of claim 17 wherein the media content comprises digital photographs.

19. The method of claim 18 wherein transmitting the media content the to receiving IP video telephone upon request further comprises transmitting one of a plurality of digital photographs to the receiving IP video telephone at specified intervals.

20. The method of claim 17 wherein transmitting the media content to a receiving IP video telephone upon request further comprises transmitting a specified digital photograph associated with a specified caller to the receiving IP video telephone when the specified caller contacts the receiving IP video telephone.
